(19) United States
(12) Patent Application Publication
(10) Pub. No.: US 2025/0096517 A1
(43) Pub. Date: Mar. 20, 2025

(54) MASTER OSCILLATOR POWER AMPLIFIER LASER SYSTEMS AND METHODS

(71) Applicant: TriEye Ltd., Tel Aviv (IL)

(72) Inventors: Stanislav Khatsevich, Tel Aviv (IL); Vincent Immer, Tel Aviv (IL); Yoni Prosper Shalibo, Tel Aviv (IL); Eyal Eli Hollander, Tel Aviv (IL); Avraham Bakal, Tel Aviv (IL); Omer Kapach, Tel Aviv (IL); Uriel Levy, Tel Aviv (IL)

(21) Appl. No.: 18/730,837

(22) PCT Filed: Jan. 25, 2023
(86) PCT No.: PCT/IB2023/050639

§ 371 Date: Jul. 22, 2024

Related U.S. Application Data
(60) Provisional application No. 63/303,136, filed on Jan. 26, 2022.

(51) Int. Cl. H01S 3/23; H01S 3/00; H01S 3/04; H01S 3/042; H01S 3/06; H01S 3/0941; H01S 3/113; H01S 3/16

(52) U.S. Cl. CPC H01S 3/2325; H01S 3/0071; H01S 3/0405; H01S 3/042; H01S 3/0606; H01S 3/09415; H01S 3/113; H01S 3/1611; H01S 3/1643

(57) ABSTRACT

Consolidated Master Oscillator Power Amplifier (MOPA) laser modules and method of fabrication thereof. A MOPA comprises a prefabricated chassis, comprising a plurality of surfaces, a master oscillator laser (MO), enduringly affixed to at least one first surface out of the plurality of surfaces, a power amplifier (PA), enduringly affixed to at least one second surface out of the plurality of surfaces, wherein a spatial relationship between the at least one first surface and the at least one second surface determines an alignment between the MO and the PA, and a beam transfer system (BTS), enduringly affixed to the prefabricated chassis, the BTS comprising a plurality of optical elements for transferring light outputted from the MO to the PA for amplification.

### CROSS REFERENCE TO RELATED APPLICATIONS

This is a 371 application from international patent application PCT/IB2023/050639 filed 25 Jan. 2023, and is related to and claims priority from U.S. provisional patent applications No. 63/303,136 filed Jan. 26, 2022, which is incorporated herein by reference in its entirety.

### FIELD

The disclosure relates to photonic systems, methods, and products. More specifically, the disclosure relates to Master Oscillator Power Amplifier (MOPA) laser systems and methods used in infrared (IR) photonics.

### BACKGROUND

Lasers operating in the short-wave infrared (SWIR) part of the electromagnetic spectrum can be hard to manufacture in high volumes, especially if low production costs are required. There is therefore a need in the art for MOPA laser systems, e.g., including passively Q-switched (P-QS) SWIR lasers which can be produced in low costs and in large numbers. Current solution for production and assembly of MOPA laser systems may require large number of elements, use of a plurality of alignment tools, testing tools and a very complicated process of system assembly. For example, master oscillator fiber amplifiers (MOFAs) require accurate and highly efficient coupling, e.g., from a solid-state laser to a single/multi-mode fiber. In case of a high-power source, the spatial shape of the laser may be complicated, which makes coupling very challenging as it may require complex beam-shaping optics, precise micro-positioning and active/passive stabilizers.

There is a need for a quick and simple alignment between the various modules and within each module which may have an advantage over current solutions such as to reduce costs, assembly time, qualification, and verification phases.

### SUMMARY

In various exemplary embodiments, there is provided a consolidated Master Oscillator Power Amplifier (MOPA) laser module, the consolidated laser module comprising: a prefabricated chassis, comprising a plurality of surfaces; a master oscillator laser (MO), enduringly affixed to at least one first surface out of the plurality of surfaces; a power amplifier (PA), enduringly affixed to at least one second surface out of the plurality of surfaces, wherein a spatial relationship between the at least one first surface and the at least one second surface determines an alignment between the MO and the PA; and a beam transfer system (BTS), enduringly affixed to the prefabricated chassis, the BTS comprising a plurality of optical elements for transferring light outputted from the MO to the PA for amplification.

In some examples, the MO is a passively Q switched laser.

In some examples, the MO comprises a crystalline saturable absorber rigidly coupled to a crystalline gain medium of the MO. In some such examples, the MO further comprises a high reflectivity mirror and an output coupler rigidly coupled to the gain medium and the saturable absorber, such that the MO is a monolithic microchip P-QS laser.

In some examples, the at least one first surface and the at least one second surfaces are polished surfaces parallel to one another.

In some examples, the amplifier comprises at least one pump and a flat crystal having an average thickness of less than 20 millimeters which is pumped by the pump, wherein light of the MO is passed through the flat crystal in multiple passes, being amplified in each of the multiple passes, and wherein the chassis comprises at least one polished surface which serves as a mirror, reflecting light from the flat crystal back into the flat crystal at least once.

In some examples, a consolidated MOPA further comprises at least one lens and folding optics, wherein an optical axis of light outputted by the MO continues to a location on an entry location on a side surface of the PA, such that light entering the PA along the optical axis is amplified and emitted at an output optical axis of the amplifier, and wherein a position of the BTS with respect to the chassis is such that light enters the BTS and leaves the BTS along the optical axis, after being deflected by the folding optics and manipulated by the at least one lens.

In some examples, a frequency of a pump source of the MO is between 750 nanometer (nm) and 850 nm, a frequency of light emitted by the MO is between 1,300 nm and 1,400 nm, a frequency of a pump source of the PA is between 750 nm and 850 nm, a frequency of light emitted by PA is between 1,300 nm and 1,400 nm, a gain medium of the MO comprises crystalline material which is Neodymium-doped Yttrium Aluminum garnet (Nd:YAG), a saturable absorber of the MO comprises crystalline material selected from a group of doped ceramic materials consisting of: (a) three-valence Vanadium-doped Yttrium Aluminum garnet (V³⁺:YAG) and (b) two-valence Cobalt-doped crystalline materials, and the PA comprises a flat Nd:YAG crystal.

In some examples, at least one part of the chassis is a part of a thermoelectric cooler (TEC) which is operable to cool at least one of the MO and the PA.

In some examples, a consolidated MOPA further comprises an intermediate mechanical coupling endurably affixed between a component of the MO or the PA and a corresponding surface of the chassis, wherein a degree of dislocation provided by the intermediate mechanical coupling and the corresponding surface is determined based on optical measurement of light emitted by the MO.

In some examples, a consolidated MOPA further comprises an internal optical sensor for measuring a sensed intensity indicative of an intensity of an internal light beam emitted by at least one of the MO and the PA, and a controller operable to trigger movement of at least one optical component of the MOPA laser module, for increasing the intensity of the internal light beam.

In some examples, a consolidated MOPA further comprises an internal temperature sensor for measuring a temperature sensed within the MOPA laser module, and a controller operable to trigger movement of at least one optical component of the MOPA laser module based on the measured temperature.

In some examples, a consolidated MOPA further comprises an internal optical sensor for measuring a sensed intensity indicative of an intensity of an internal light beam emitted by at least one of the MO and the PA, and a controller operable to trigger modification of an electric magnitude of a controlled component of the MOPA laser module, for increasing the intensity of the internal light beam.

In some examples, a consolidated MOPA further comprises an internal temperature sensor for measuring a temperature sensed within the MOPA laser module, and a controller operable to trigger modification of an electric magnitude of a controlled component of the MOPA laser module based on the measured temperature and on temperature correction information at a tangible memory module accessible by the controller.

In some examples, the BTS comprises an optical entrance, for receiving a light beam of a MO laser module along an entry optical axis, an optical egress, for emitting a manipulated light beam towards a PA along an egress optical axis, a plurality of lenses, at least one of which is shaped for manipulating the light beam and for fitting to at least one dedicated three-dimensional (3D) structure of a chassis, and folding optics comprising a plurality of folding optical components comprising at least one type of components selected from a group consisting of mirrors and prisms, the folding optics operable to deflect light entering the BTS along the entry optical axis towards at least one lens of the plurality of lenses, and to deflect light arriving from at least one other lens of the plurality of lens toward the egress optical axis, wherein at least one of the folding optical components is shaped for manipulating the light beam and for fitting to at least one customized 3D structure of the chassis. In some examples, the chassis has at least a portion which comprises the at least one dedicated 3D structure and the at least one customized 3D structure. In some examples, at least one of the folding optical components is controllably movable by at least one other component of the BTS, for adjusting a position of the respective folding optical component to the respective customized 3D structure. In some examples, at least one of the folding optical components is a pentaprism having four active surfaces, operable to internally reflect the light beam inside the pentaprism twice before emitting the light beam out of the pentaprism. In some examples, at least one of the folding optical components is a retroreflector having at least three active sides, operable to internally reflect the light beam inside the retroreflector twice before emitting the light beam out of the retroreflector. In some examples, the egress optical axis is a continuation of the entry optical axis.

In various exemplary embodiments, there is provided a method of manufacturing a consolidated MOPA laser module, comprising: enduringly affixing to different surfaces of a prefabricated chassis at least one component of a MO and at least one component of a PA, wherein the affixing to the prefabricated chassis of the at least one MO component and the at least one PA component determines an alignment between the MO and the PA; and after the affixing of the at least one MO component and the at least one PA component, enduringly coupling to the prefabricated chassis a BTS, the BTS comprising a plurality of optical elements for transferring light outputted from the MO to the PA, for amplification.

In some examples, the affixing comprising directing the MO directly towards the PA, sensing an output of the PA resulting from the illumination, adjusting an alignment between the MO and the PA based on results of the sensing, and affixing at least one component of at least one of the MO and the PA based on the adjusted alignment.

In some examples, a method further comprises measuring output of the PA at two or more different temperatures and at two or more different states of at least one controllable optical component (COC) of the BTS, computing temperature compensation information for the at least one COC, and storing the temperature correction information at a tangible memory module which is readable by a controller that is operable to modify a state of the at least one COC.

In some examples, a method further comprises measuring output of the PA at two or more different temperatures and at two or more different states of at least one thermoelectric cooler (TEC) of MOPA laser module, computing temperature compensation information for the at least one TEC, and storing the temperature correction information at a tangible memory module which is readable by a controller that is operable to modify a state of the at least one TEC.

In some examples, a method further comprises measuring output of the PA at two or more different temperatures and at two or more different states of at least one pump of the MO or the PA, computing temperature compensation information for the at least one pump, and storing the temperature correction information at a tangible memory module which is readable by a controller that is operable to modify a state of the at least one pump.

In some examples, the enduringly affixing is preceded by polishing at least one first surface and at least one second surface of the chassis to be parallel to one another, wherein the enduringly affixing comprising enduringly affixing the at least one component of the MO to the first surface and enduringly affixing the at least one component of the PA to the second surface.

### BRIEF DESCRIPTION OF THE DRAWINGS

In order to understand the disclosure and to see how it may be carried out in practice, embodiments will now be described, by way of non-limiting examples only and in accordance with examples of the presently disclosed subject matter, with reference to the accompanying drawings, in which:

FIG. 1 is a schematic functional block diagram illustrating an example of a short-wave infrared (SWIR) optical system;

FIGS. 2A, 2B, and 2C are schematic functional block diagrams illustrating examples of a P-QS laser;

FIG. 3 is a schematic functional diagram illustrating an exemplary implementation of a SWIR optical system;

FIG. 4 is a schematic functional diagram illustrating another exemplary implementation of a SWIR optical system;

FIG. 5 is a schematic functional block diagram illustrating an example of a SWIR optical system;

FIG. 6A is a flow chart illustrating an example of a method for manufacturing parts for a P-QS laser;

FIGS. 6B and 6C include several conceptual timelines for the execution of the aforementioned method;

FIGS. 7 and 8 illustrate exemplary exploded view perspective projections of gain medium amplifiers (GMAs) in accordance with examples of the presently disclosed subject matter;

FIGS. 9 and 10 illustrate exemplary exploded view perspective projections of gain medium amplifiers (GMAs) and amplified laser illumination sources in accordance with examples of the presently disclosed subject matter;

FIGS. 11A, 11B and 11C are schematic functional block diagrams illustrating exemplary MOPA systems, in accordance with the presently disclosed subject matter;

FIG. 12 is a side view illustrating exemplary components of MOPA laser module and chassis, in accordance with the presently disclosed subject matter;

FIGS. 13A, 13B, 13C, 13D and 13E illustrate exemplary beam transfer systems, in accordance with the presently disclosed subject matter;

FIG. 14 is a flow chart of an example process for a method of manufacturing a consolidated MOPA laser module according to some implementation of the presently disclosed subject matter.

### DETAILED DESCRIPTION

In order to understand the disclosure and to see how it may be carried out in practice, embodiments will now be described, by way of non-limiting examples only, with reference to the accompanying drawings. It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the following detailed description, numerous specific details are set forth in order to provide a thorough understanding of the disclosure. However, it will be understood by those skilled in the art that the present disclosure may be practiced without these specific details. In other instances, well-known methods, procedures, and components have not been described in detail so as not to obscure the present disclosure.

In the drawings and descriptions set forth, identical reference numerals indicate those components that are common to different embodiments or configurations.

The terms “computer”, “processor”, and “controller” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and/or any combination thereof.

The operations in accordance with the teachings herein may be performed by a computer specially constructed for the desired purposes or by a general purpose computer specially configured for the desired purpose by a computer program stored in a computer readable storage medium, particularly a non-transitory computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages illustrated in the figures may be executed in a different order and/or one or more groups of stages may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

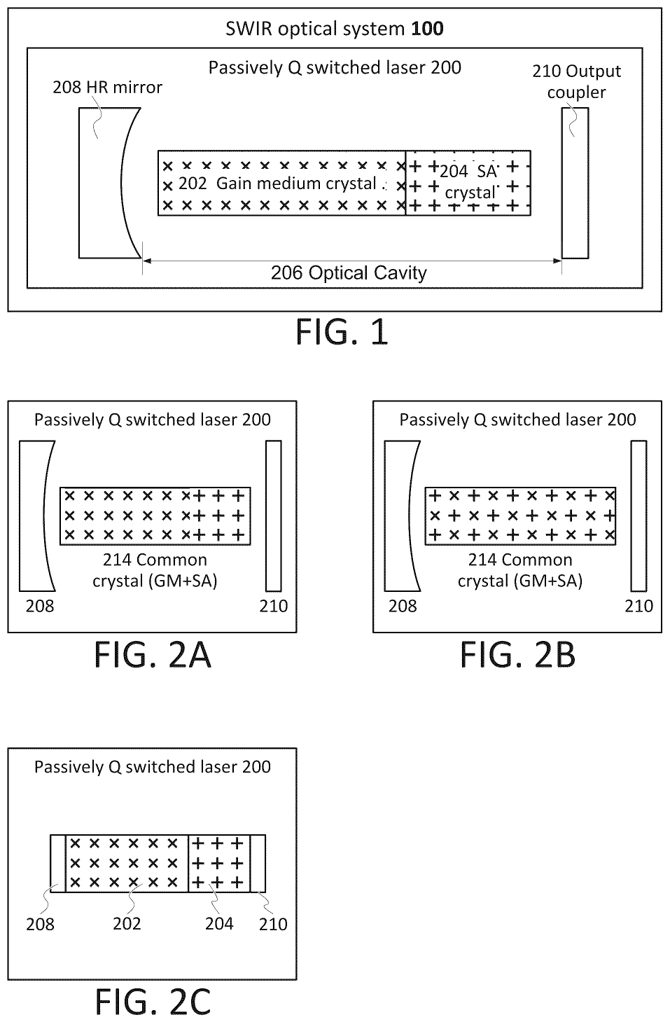

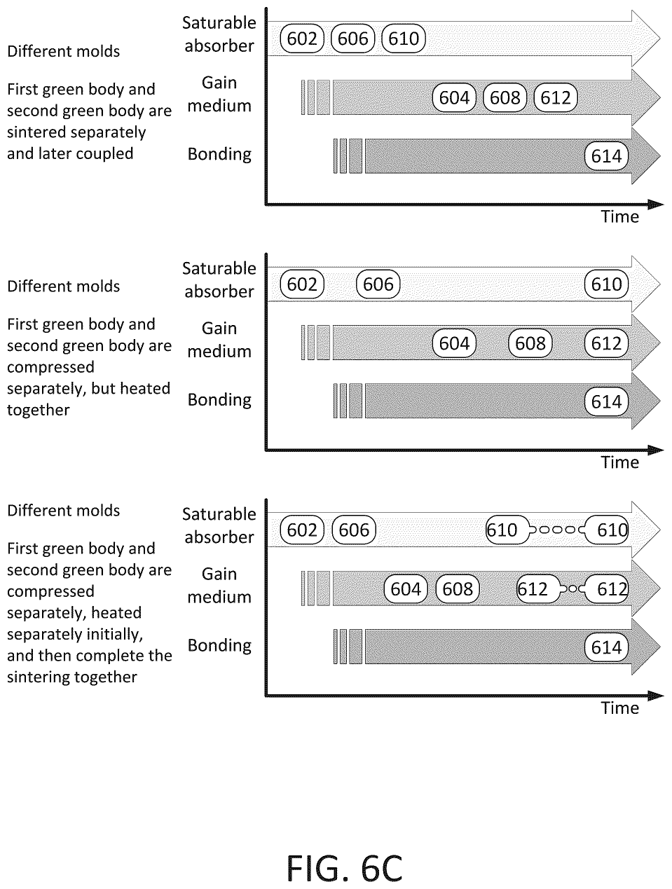

FIG. 1 is a schematic functional block diagram illustrating an example of SWIR optical system 100, in accordance with examples of the presently disclosed subject matter. System 100 comprises at least a passively Q-switched (P-QS) laser 200, but may also comprise, as shown in FIG. 5, additional components such as:
a. a sensor 102 operative to sense reflected light from the FOV of system 100, and especially reflected illumination of laser 200 reflected from external objects 500. Referring to the other examples, sensor 102 may be implemented as imaging receiver, PDA or photodetecting devices discussed in the present disclosure.
b. a processor 104, operative to process the sensing results of sensor 102. The output of the processing may be an image of the FOV, a depth model of the FOV, spectroscopy analysis of one or more parts of the FOV, information of identified objects in the FOV, light statistics on the FOV, or any other type of output. Referring to the other examples, processor 104 may be implemented as any one of the processors discussed in the present disclosure.
c. a controller 106, operative to control activity of laser 200 and/or processor 104. For example, controller 106 may include controlling timing, synching, and other operational parameters of processor 104 and/or laser 200.

Optionally, system 100 may include a SWIR PDA 108 sensitive to the wavelength of the laser. This way SWIR optical system may serve as an active SWIR camera, SWIR time-of-flight (ToF) sensor, SWIR light detection and ranging (LIDAR) sensor, and so on. The ToF sensor may be sensitive to the wavelength of the laser. Optionally, the PDA may be a CMOS based PDA which is sensitive to SWIR frequencies emitted by laser 200, such is a CMOS based PDAs designed and manufactured by TriEye LTD. Of Tel Aviv, Israel.

Processor 104 may be used for processing detection data from the SWIR PDA (or any other light sensitive sensor of system 100). For example, the processor may process the detection information to provide a SWIR image of a field-of-view (FOV) of system 100, to detect objects in the FOV, and so on. Optionally, the SWIR optical system may include a time of flight (ToF) SWIR sensor sensitive to the wavelength of the laser, and a controller operative to synchronize operation of the ToF SWIR sensor and the P-QS SWIR laser for detecting a distance to at least one object in the field of view of the SWIR optical system. Optionally, system 100 may include controller 106 operative to control one or more aspects of an operation of laser 200 or other components of the system such as the photodetector array (e.g., focal plane array, FPA). For example, some of the parameters of the laser which may be controlled by the controller include timing, duration, intensity, focusing, and so on. While not necessarily so, the controller may control operation of the laser based on detection results of the PDA (directly, or based on processing by the processor). Optionally, the controller may be operative to control the laser pump or other type of light source to affect activation parameters of the laser. Optionally, the controller may be operative to dynamically change the pulse repetition rate. Optionally, the controller may be operative to control dynamic modification of the light shaping optics, e.g., for improving a Signal to Noise Ratio (SNR) in specific regions of the field of view. Optionally, the controller may be operative to control the illumination module for dynamically changing pulse energy and/or duration, (e.g., in the same ways possible for other P-QS lasers, such as changing focusing of pumping laser, etc.)

Further and optionally, system 100 may include temperature control (e.g., passive temperature control, active temperature control) for controlling a temperature of the laser generally, or of one or more of its components (e.g., of the pump diode). Such temperature control may include, for example, a thermoelectric cooler (TEC), a fan, a heat sink, resistance heater under pump diode, and so forth.

Further and optionally, system 100 may include another laser which used to bleach at least one of gain medium (GM) 202 and saturable absorber (SA) 204. Optionally, system 100 may include an internal photosensitive detector (e.g., one or more PDs like PDA 108) which is operative to measure a time in which a pulse is generated by laser 200 (e.g., as PD 226 as discussed above). In such case, controller 106 may be operative to issue, based on the timing information obtained from internal photosensitive detector, a triggering signal to PDA 108 (or other type of camera or sensor 102) which detects reflection of laser light from objects in the field of view of system 100.

The main industry that has required high volumes of lasers in the aforementioned spectral range (1.3-1.5 μm) is the electronics industry for optical data storage, which drove the diode laser cost down to dollars, or less, per device, per Watt. However, those lasers are not suitable for other industries such as the automotive industry, which requires lasers with considerably greater peak power and beam brightness, and which will be utilized in harsh environmental conditions.

It is noted that there is no scientific consensus about the range of wavelengths which are considered part of the SWIR spectrum. Nevertheless, for the purposes of the present disclosure, the SWIR spectrum includes electromagnetic radiation in wavelengths which are longer than that of the visible spectrum, and which include at the very least the spectral range between 1,300 nm and 1,500 nm.

While not restricted to such uses, one or more P-QS lasers 200 may be used as illumination source of any imaging system. Laser 200 may be used in any other electro optical (EO) system operating in the SWIR range which requires pulsed illumination such as lidars, spectrographs, communication systems, and so on. It is noted that the proposed lasers 200 and methods for manufacturing of such lasers allows for high volume manufacturing of lasers operating in the SWIR spectral range in relatively low production costs.

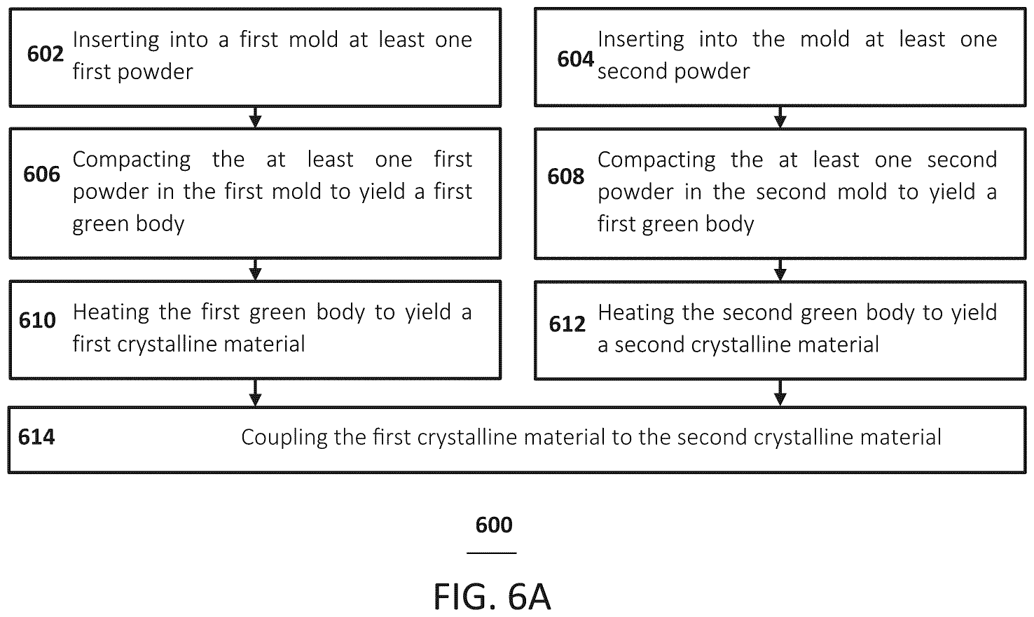

Reference is made back to FIG. 1, P-QS laser 200 includes at least a crystalline GM 202, a crystalline SA 204, and an optical cavity 206 in which the aforementioned crystalline materials are confined, to allow light propagating within gain medium 202 to intensify towards producing a laser light beam 212 (illustrated for example in FIG. 3). The optical cavity is also known by the terms “optical resonator” and “resonating cavity”, and it includes a high reflectivity mirror 208 (also referred to as “high reflector” or “HR”) and an output coupler 210. Discussed below are several unique and novel combinations of crystalline materials of different types, and using varied manufacturing techniques for manufacturing the lasers, which allow for high volume manufacturing of reasonably priced lasers for the SWIR spectral range. General details which are generally known in the art with respect to P-QS lasers are not provided here for reasons of conciseness of the disclosure, but are readily available from a wide variety of resources. The saturable absorber of the laser serves as the Q-switch for the laser, as is known in the art. The term “crystalline material” broadly includes any material which is in either monocrystalline form or polycrystalline form.

The dimensions of the connected crystalline gain medium and crystalline SA may depend on the purpose for which a specific P-QS laser 200 is designed. In a non-limiting example, a combined length of the SA and the GM is between 5 and 15 millimeters. In a non-limiting example, the combined length of the SA and the GM is between 2 and 40 millimeters. In a non-limiting example, a diameter of the combination of SA and GM (e.g., if a round cylinder, or confined within an imaginary such cylinder) is between 2 and 5 millimeters. In a non-limiting example, a diameter of the combination of SA and GM is between 0.5 and 10 millimeters.

P-QS laser 200 includes a gain medium crystalline material (GMC) which is rigidly connected to a SA crystalline material (SAC). The rigid coupling may be implemented in any one of the ways known in the art such as using adhesive, diffusion bonding, composite crystal bonding, growing one on top of the other, and so on. However, as discussed below, rigidly connecting crystalline materials which are in a ceramic form may be achieved using simple and cheap means. It is noted that the GMC and the SAC material may be rigidly connected directly to one another, but may optionally be rigidly connected to one another via an intermediate object (e.g., another crystal). In some implementation, both the gain medium and the SA may be implemented on single piece of crystalline material, by doping different parts of the single piece of crystalline material with different dopants (such as the ones discussed below with respect to SAC materials and to GMC materials), or by co-doping a single piece of crystalline material, doping the same volume of the crystalline material with the two dopants (e.g., a ceramic YAG co-doped with N³⁺ and V³⁺). Optionally, the gain medium may be grown on a single crystal saturable absorbing substrate (e.g., using Liquid Phase Epitaxy, LPE). It is noted that separate GMC material and SA crystalline material are discussed extensively in the disclosure below, a single piece of ceramic crystalline material doped with two dopants may also be used in any of the following implementations, mutatis mutandis.

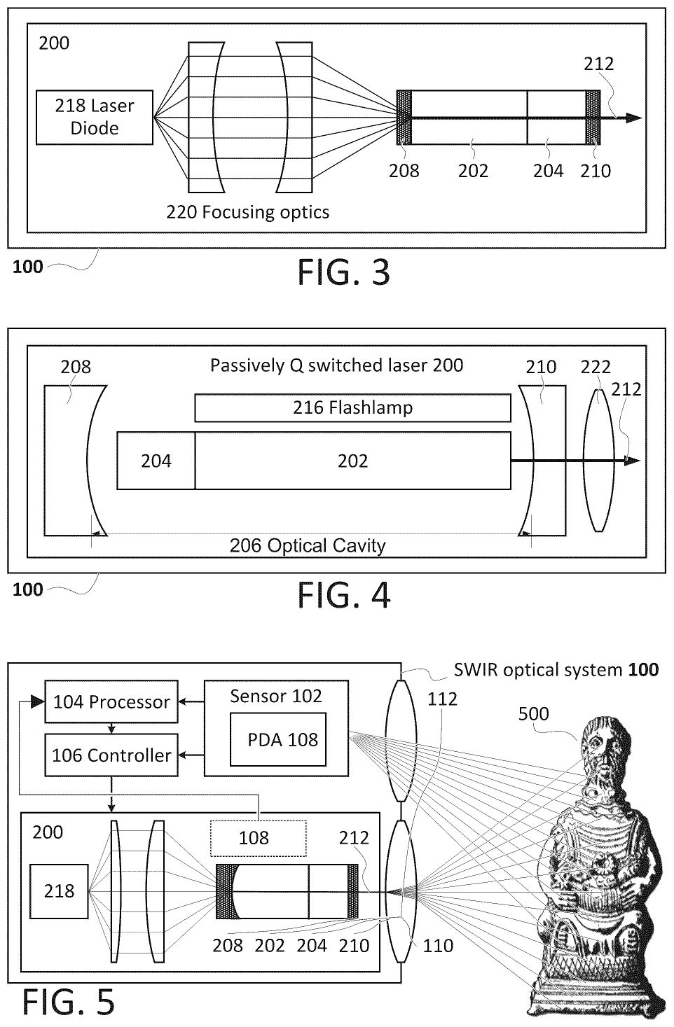

FIGS. 2A, 2B and 2C are schematic functional block diagrams illustrating examples of P-QS laser 200, in accordance with the presently disclosed subject matter. In FIG. 2A the two dopants are implemented on two parts of the common crystalline material 214 (acting both as GM and as SA), while in FIG. 2B the two dopants are implemented interchangeably on common volume of the common crystalline material 214 (in the illustrated case—the entirety of the common crystal). Optionally, the GM and the SA may be implemented on a single piece of crystalline material doped with neodymium and at least one other material. Optionally (e.g., as exemplified in FIG. 2C), any one or both of output coupler 210 and high reflectivity mirror 208 may be glued directly to one of the crystalline materials (e.g., the GM or the SA, or a crystal combining both).

At least one of SAC and the GMC is a ceramic crystalline material, which is the relevant crystalline material (e.g., doped yttrium aluminum garnet, YAG, doped vanadium) in a ceramic form (e.g., a polycrystalline form). Having one—and especially both—crystalline materials in ceramic form allows for production in higher numbers and in lower costs. For example, instead of growing separate monocrystalline materials in a slow and limited process, polycrystalline materials may be manufactured by sintering of powders (i.e., compacting and possibly heating a powder to form a solid mass), low temperature sintering, vacuum sintering, and so on. One of the crystalline materials (SAC or GMC) may be sintered on top of the other, obviating the need for complex and costly processes such as polishing, diffusion bonding, or surface activated bonding. Optionally, at least one of the GMC and SAC is polycrystalline. Optionally, both the GMC and the SAC is polycrystalline.

Referring to the combinations of crystalline materials from which the GMC and the SAC may be made, such combinations may include:
a. The GMC is ceramic neodymium-doped yttrium aluminum garnet (Nd:YAG) and the SAC is either (a) ceramic three-valence vanadium-doped yttrium aluminum garnet (V³⁺:YAG), or (b) a ceramic Cobalt-doped crystalline material. Optionally, the ceramic Cobalt-doped crystalline material may be two-valence ceramic Cobalt-doped crystalline material. In those alternatives, both the Nd:YAG and the SAC selected from the aforementioned group are in ceramic form. A cobalt-doped crystalline material is a crystalline material which is doped with cobalt. Examples include Cobalt-doped Spinel (Co:Spinel, or Co²⁺:MgAl₂O₄) cobalt-doped Zinc selenide (Co²⁺:ZnSe), cobalt-doped YAG (Co²⁺:YAG). While not necessarily so, the high reflectivity mirror and the SA in this option may optionally be rigidly connected to the gain medium and the SA, such that the P-QS laser is a monolithic microchip P-QS laser (e.g., as exemplified in FIGS. 3 and 5).
b. The GMC is a ceramic neodymium-doped yttrium aluminum garnet (Nd:YAG), and the SAC is a nonceramic SAC selected from a group of doped ceramic materials consisting of: (a) three-valence vanadium-doped yttrium aluminum garnet (V³⁺:YAG) and (b) Cobalt-doped crystalline materials. Optionally, the Cobalt-doped crystalline material may be two-valence Cobalt-doped crystalline material. In such case, high reflectivity mirror 208 and output coupler 210 are rigidly connected to the gain medium and the SA, such that P-QS laser 200 is a monolithic microchip P-QS laser.
c. The GMC which is ceramic neodymium-doped rare-earth element crystalline material, and the SAC is a ceramic crystalline material selected from a group of doped crystalline materials consisting of: (a) three-valence vanadium-doped yttrium aluminum garnet (V³⁺:YAG) and (b) Cobalt-doped crystalline materials. Optionally, the Cobalt-doped crystalline material may be two-valence Cobalt-doped crystalline material. While not necessarily so, high reflectivity mirror 208 and output coupler 210 in this option may optionally be rigidly connected to the gain medium and the SA, such that P-QS laser 200 is a monolithic microchip P-QS laser.

It is noted that in any one of the implementations, a doped crystalline material may be doped with more than one dopant. For example, the SAC may be doped with the main dopant disclosed above, and with at least one other doping material (e.g., in significantly lower quantities). A neodymium-doped rare-earth element crystalline material is a crystalline material whose unit cell comprises a rare-earth element (one of a well-defined group of 15 chemical elements, including the fifteen lanthanide elements, as well as scandium and yttrium) and which is doped with neodymium (e.g., triply ionized neodymium) which replaces the rear-earth element in a fraction of the unit cells. Few non-limiting examples of neodymium-doped rare-earth element crystalline material which may be used in the disclosure are:
a. Nd:YAG (as mentioned above), neodymium-doped tungstic acid yttrium potassium (Nd:KYW), neodymium-doped yttrium lithium fluoride (Nd:YLF), neodymium-doped yttrium orthovanadate (YVO₄), in all of which the rear-earth element is Neodymium, Nd;
b. Neodymium-doped gadolinium orthovanadate (Nd:GdVO₄), neodymium-doped Gadolinium Gallium Garnet (Nd:GGG), neodymium-doped potassium-gadolinium tungstate (Nd:KGW), in all of which the rear-earth element is gadolinium, Gd);
c. Neodymium-doped lanthanum scandium borate (Nd:LSB) in which the rare-earth element is scandium);
d. Other neodymium-doped rare-earth element crystalline materials may be used, in which the rare-earth element may be yttrium, gadolinium, scandium, or any other rare-earth element.

The following discussion applies to any of the optional combinations of GMCs and SACs.

Optionally, the GMC is rigidly connected directly to the SAC. Alternatively, the GMC and the SAC may be connected indirectly (e.g., each of the SAC and GMC being connected via a group of one or more intermediate crystalline materials and/or via one or more other solid materials transparent to the relevant wavelengths). Optionally one or both of the SAC and the GMC are transparent to the relevant wavelengths.

Optionally, the SAC may be cobalt-doped Spinel (Co Co²⁺:MgAl2O4). Optionally, the SAC may be cobalt-doped YAG (Co:YAG). Optionally, this may enable co-doping of cobalt and neodymium Nd on the same YAG. Optionally, the SAC may be cobalt-doped Zinc selenide (Co²⁺:ZnSe). Optionally, the GMC may be a ceramic cobalt-doped crystalline material.

Optionally, an initial transmission (T₀) of the SA is between 75% and 90%. Optionally, the initial transmission of the SA is between 78% and 82%.

The wavelengths emitted by the laser depend on the material used in its construction, and especially on the materials and dopants of the GMC and the SAC. Some examples of output wavelengths include wavelengths in the range of 1,300 nm and 1,500 nm. Some more specific examples include 1.32 μm or about 1.32 μm (e.g., 1.32 μm±3 nm), 1.34 μm or about 1.34 μm (e.g., 1.34 μm±3 nm), 1.44 μm or about 1.44 μm (e.g., 1.44 μm±3 nm). A corresponding imager sensitive to one or more of these light frequency ranges may be included in SWIR optical system 100 (e.g., as exemplified in FIG. 5).

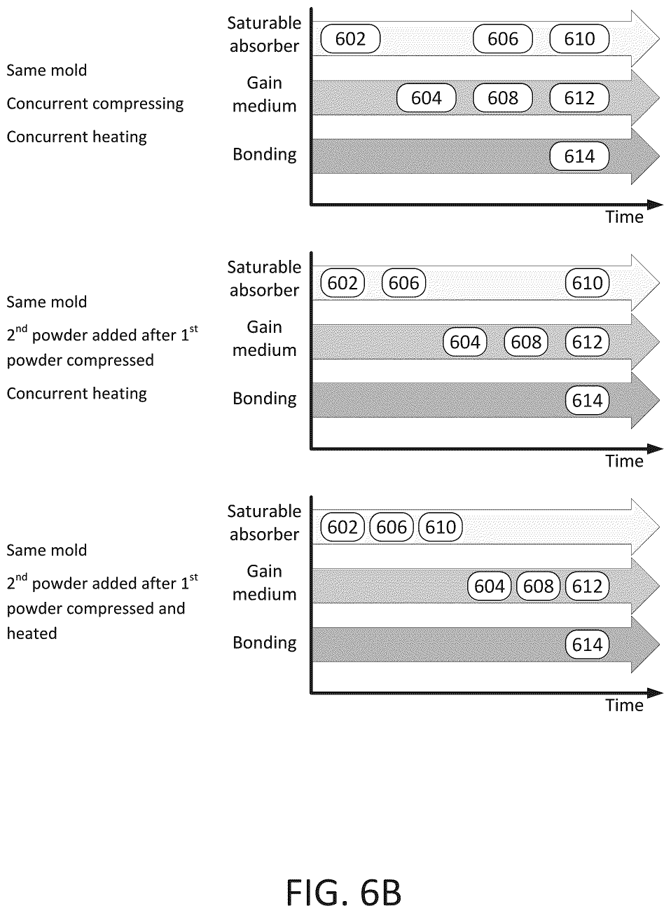

FIGS. 3 and 4 are schematic functional diagrams illustrating SWIR optical system 100, in accordance with examples of the presently disclosed subject matter. As exemplified in these illustrations, laser 200 may include additional components in addition to those discussed above, such as (but not limited to):
a. a light source such as a flashlamp 216 or a laser diode 218 which serves as a pump for the laser;
b. Focusing optics 220 (e.g., lenses) for focusing light from the light source (e.g. light diode 218) onto the optical axis of laser 200;
c. a diffuser or other optics 222 for manipulating laser beam 212 after it exits optical cavity 206.

Optionally, as shown in FIG. 5, SWIR optical system 100 may include optics 110 to spread the laser over a wider FOV, to improve eye safety issues in the FOV. Optionally, SWIR optical system 100 may include optics 112 to collect reflected laser light from the FOV and directing it onto the sensor 102, e.g., onto a photodetector array (PDA) 108. Optionally the P-QS laser 200 is a diode pumped solid state laser (DPSSL).

Optionally, P-QS laser 200 includes at least one diode pump light source 218 and optics 220 for focusing light of the diode pump light source into the optical resonator (optical cavity). Optionally, the light source is positioned on the optical axis (as an end pump). Optionally, the light source may be rigidly connected to high reflectivity mirror 208 or to SA 204, such that the light source is a part of a monolithic microchip P-QS laser. Optionally, the light source of the laser may include one or more vertical-cavity surface-emitting laser (VCSEL) arrays. Optionally, P-QS laser 200 includes at least one VCSEL array and optics for focusing light of the VCSEL array into the optical resonator. The wavelengths emitted by the light source (e.g., the laser pump) may depend on the crystalline materials and/or dopants used in the laser. Some exemplary pumping wavelengths which may be emitted by the pump include: 808 nm or about 808 nm, 869 nm or about 869 nm.

The power of the laser may depend on the utilization for which it is designed. For example, the laser output power may be between 1 W and 5 W. For example, the laser output power may be between 5 W and 15 W. For example, the laser output power may be between 15 W and 50 W. For example, the laser output power may be between 50 W and 200 W. For example, the laser output power may be higher than 200 W.

P-QS laser 200 is a pulsed laser, and may have different frequency (repetition rate), different pulse energy, and different pulse duration, which may depend on the utilization for which it is designed. For example, a repetition rate of the laser may be between 10 Hz and 50 Hz. For example, a repetition rate of the laser may be between 50 Hz and 150 Hz. For example, a pulse energy of the laser may be between 0.1 mJ and 1 mJ. For example, a pulse energy of the laser may be between 1 mJ and 2 mJ. For example, a pulse energy of the laser may be between 2 mJ and 5 mJ. For example, a pulse energy of the laser may be higher than 5 mJ. For example, a pulse duration of the laser may be between 10 ns and 100 ns. For example, a pulse duration of the laser may be between 0.1 μs and 100 μs. For example, a pulse duration of the laser may be between 100 μs and 1 ms. The size of the laser may also change, depending for example on the size of its components. For example, the laser dimensions may be X₁ by X₂ by X₃, wherein each of the dimensions (X₁, X₂, and X₃) is between 10 mm and 100 mm, between 20 and 200 mm, and so on. The output coupling mirror may be flat, curved, or slightly curved.

Optionally, laser 200 may further include undoped YAG in addition to the gain medium and to the SA, for preventing heat from accumulating in an absorptive region of the gain medium. The undoped YAG may optionally be shaped as a cylinder (e.g., a concentric cylinder) encircling the gain medium and the SA.

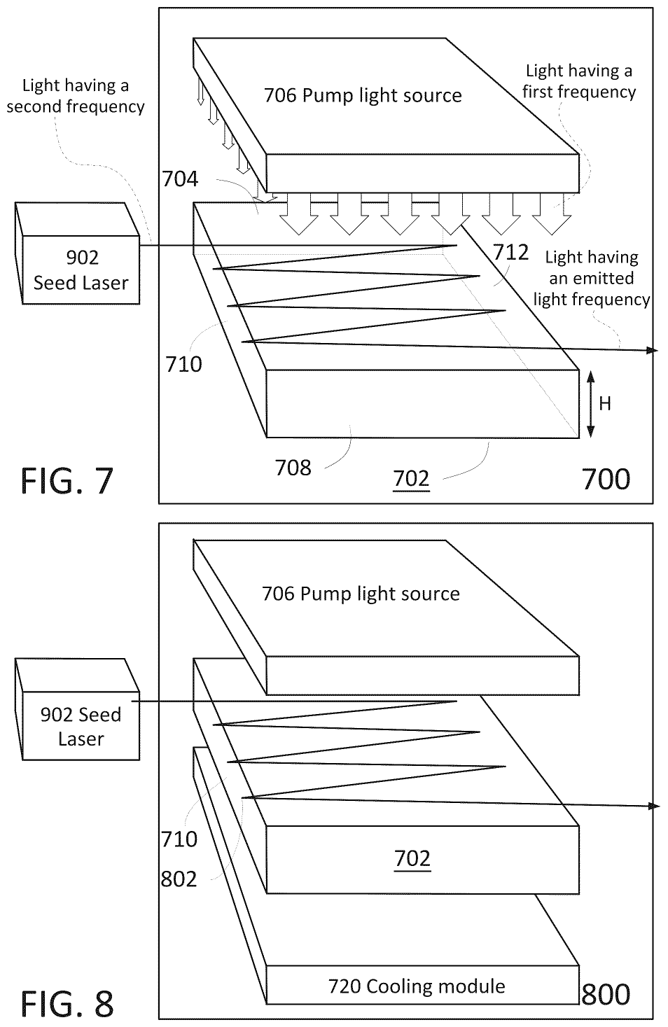

FIG. 6A is a flow chart illustrating an example of method 600, in accordance with the presently disclosed subject matter. Method 600 is a method for manufacturing parts for a P-QS laser such as but not limited to P-QS laser 200 discussed above. Referring to the examples set forth with respect to the previous drawings, the P-QS laser may be laser 200. It is noted that any variation discussed with respect to laser 200 or to a component thereof may also be implemented for the P-QS laser whose parts are manufactured in method 600 or to a corresponding component thereof, and vice versa.

Method 600 starts with step 602 of inserting into a first mold at least one first powder, which is processed later in method 600 to yield a first crystalline material. The first crystalline material serves as either the GM or the SA of the P-QS laser. In some implementations the gain medium of the laser is made first (e.g., by way of sintering), and the SA is made later on top of the previously made GM (e.g., by way of sintering). On other implementations, the SA of the laser is made first, and the GM is made later on top of the previously made SA. In yet other implementations, the SA and the GM are made independently of one another, and are coupled to form a single rigid body. The coupling may be done as part of the heating, sintering, or later.

Step 604 of method 600 includes inserting into a second mold at least one second powder different than the at least one first powder. The at least one second powder is processed later in method 600 to yield a second crystalline material. The second crystalline material serves as either the GM or the SA of the P-QS laser (so that one of the SA and the GM is made from the first crystalline material and the other functionality is made from the second crystalline material).

The second mold may be different from the first mold. Alternatively, the second mold may be the same as the first mold. In such case the at least one second powder may be inserted, for example, on top of the at least one first powder (or on top of the first green body, if already made), beside it, around it, and so on. The inserting of the at least one second powder into the same mold of the at least one first powder (if implemented) may be executed before processing of the at least one first powder into a first green body, after processing of the at least one first powder into the first green body, or sometime during the processing of the at least one first powder into the first green body.

The first powder and/or the second powder may include crushed YAG (or any of the other aforementioned materials such as Spinel, MgAl₂O₄, ZnSe) and doping materials (e.g., N³⁺, V³⁺, Co). The first powder and/or the second powder may include materials from which YAG (or any of the other aforementioned materials such as Spinel, MgAl₂O₄, ZnSe) is made and doping material (e.g., N³⁺, V³⁺, Co).

Step 606 is executed after step 602 and includes compacting the at least one first powder in the first mold to yield a first green body. Step 604 is executed after step 608, that includes compacting the at least one second powder in the second mold, thereby yielding a second green body. If the at least one first powder and the at least one second powder are inserted into the same mold in steps 602 and 604, the compacting of the powders in step 606 and 608 may be done concurrently (e.g., pressing on the at least one second powder, which in turn compresses the at least one first powder against the mold), but this is not necessarily so. For example, step 604 (and therefore also step 608) may optionally be executed after the compressing of step 606.

Step 610 includes heating the first green body to yield a first crystalline material. Step 612 includes heating the second green body to yield a second crystalline material. In different embodiments, the heating of the first crystalline material may be executed before, concurrently, partly concurrently, or after each one of steps 606 and 610. Step 614 includes coupling the second crystalline material to the first crystalline material.

Optionally, the heating of the first green body at step 610 precedes the compacting (and possibly also precedes the inserting) of the at least one second powder in step 608 (and possibly step 604). The first green body and the second green body may be heated separately (e.g., in different times, in different temperatures, for different durations). The first green body and the second green body may be heated together (e.g., in the same oven), either connected to each other during the heating or not. The first green body and the second green body may be subject to different heating regimes, which may share partial co-heating, while being heated separately in other parts of the heating regimes. For example, one or both of the first green body and the second green body may be heated separately from the other green body, and then the two green bodies may be heated together (e.g., after coupling, but not necessarily so). Optionally, the heating of first green body and the heating of the second green body comprise concurrent heating of the first green body and the second green body in a single oven. It is noted that optionally, the coupling of step 614 is a result of the concurrent heating of both of the green bodies in the single oven. It is noted that optionally, the coupling of step 614 is done by co-sintering both of the green bodies after being physically connected to one another.

Step 614 includes coupling the second crystalline material to the first crystalline material. The coupling may be executed in any way of coupling known in the art, several non-limiting examples of which were discussed above with respect to P-QS laser 200. It is noted that the coupling may have several sub-steps, some of which may intertwine with different steps out of steps 606, 608, 610, and 612 in different manners in different embodiments. The coupling results in a single rigid crystalline body that includes both the GM and the SA.

It is noted that method 600 may include additional steps which are used in the making of crystals (and especially in the making of ceramic or non-ceramic polycrystalline crystal compounds of polycrystalline materials which are bounded to each other). Few non-limiting examples include powder preparation, binder burn-out, densification, annealing, polishing (if required, as discussed below), and so on.

The GM of the P-QS laser in method 600 (which, as aforementioned, can be either the first crystalline material or the second crystalline material), is a neodymium-doped crystalline material. The SA of the P-QS laser in method 600 (which, as aforementioned, can be either the first crystalline material or the second crystalline material), is selected from a group of crystalline materials consisting of: (a) a neodymium-doped crystalline material, and (b) a doped crystalline material selected from a group of doped crystalline materials consisting of: three-valence vanadium-doped yttrium aluminum garnet (V³⁺:YAG) and cobalt-doped crystalline materials. At least one of the GM and the SA is a ceramic crystalline material. Optionally, both of the GM and the SA are ceramic crystalline materials. Optionally, at least one of the GM and the SA is a polycrystalline material. Optionally, both the GM and the SA are polycrystalline materials.

While additional steps of the manufacturing process may take place between the different stages of method 600, notably polishing of the first material before bonding of the second material in the process of sintering is not required in at least some of the implementations.

Referring to the combinations of crystalline materials from which the GMC and the SAC may be made in method 600, such combinations may include:
a. the GMC is ceramic neodymium-doped yttrium aluminum garnet (Nd:YAG), and the SAC is either (a) ceramic three-valence vanadium-doped yttrium aluminum garnet (V³⁺:YAG), or (b) a ceramic Cobalt-doped crystalline material. In this alternatives, both the Nd:YAG and the SAC selected from the aforementioned group are in ceramic form. A cobalt-doped crystalline material is a crystalline material which is doped with cobalt. Examples include Cobalt-doped Spinel (Co:Spinel, or Co²⁺:MgAl₂O₄) cobalt-doped Zinc selenide (Co²⁺:ZnSe). While not necessarily so, the high reflectivity mirror and the output coupler in this option may optionally be rigidly connected to the GM and the SA, such that the P-QS laser is a monolithic microchip P-QS laser;
b. the GMC is a ceramic neodymium-doped yttrium aluminum garnet (Nd:YAG), and the SAC is a nonceramic SAC selected from a group of doped ceramic materials consisting of: (a) three-valence vanadium-doped yttrium aluminum garnet (V³⁺:YAG) and (b) Cobalt-doped crystalline materials. In such case, the high reflectivity mirror and the output coupler are rigidly connected to the GM and the SA, such that the P-QS laser is a monolithic microchip P-QS laser;
c. the GMC which is ceramic neodymium-doped rare-earth element crystalline material, and the SAC is a ceramic crystalline material selected from a group of doped crystalline materials consisting of: (a) three-valence vanadium-doped yttrium aluminum garnet (V³⁺:YAG) and (b) Cobalt-doped crystalline materials. While not necessarily so, the high reflectivity mirror and the output coupler in this option may optionally be rigidly connected to the GM and the SA, such that the P-QS laser is a monolithic microchip P-QS laser.

Referring to method 600 as a whole, it is noted that optionally one or both of the SAC and the GMC (and optionally one or more intermediate connecting crystalline materials, if any) are transparent to the relevant wavelengths (e.g., SWIR radiation).

FIGS. 6B and 6C include several conceptual timelines for the execution of method 600, in accordance with examples of the presently disclosed subject matter. To simplify the drawing, it is assumed that the SA is a result of the processing of the at least one first powder, and that the gain medium is a result of the processing of the at least one second powder. As mentioned above, the roles may be reversed.

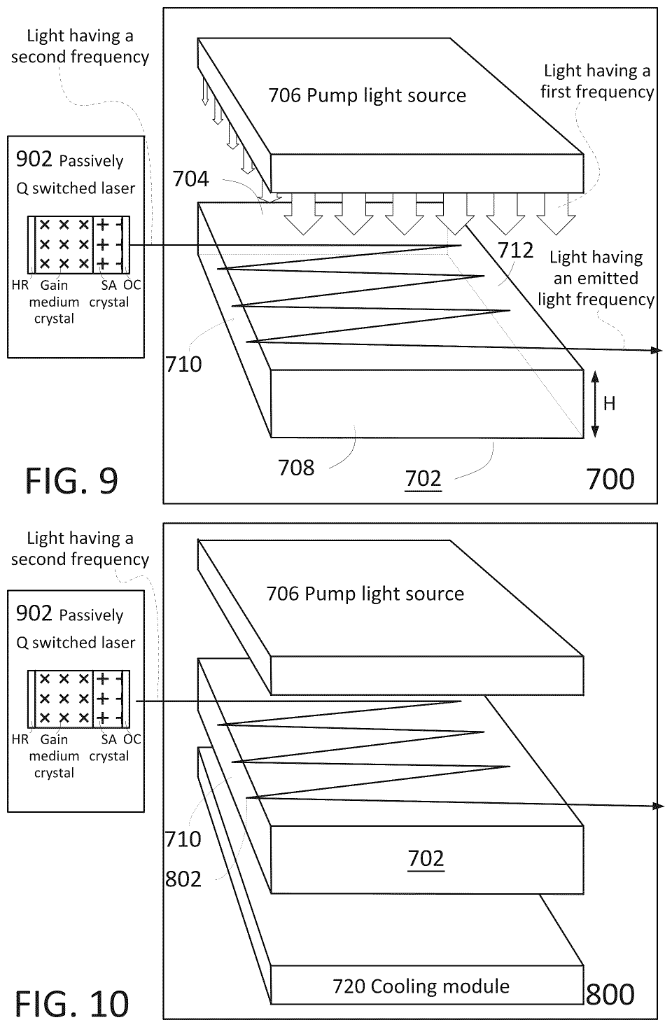

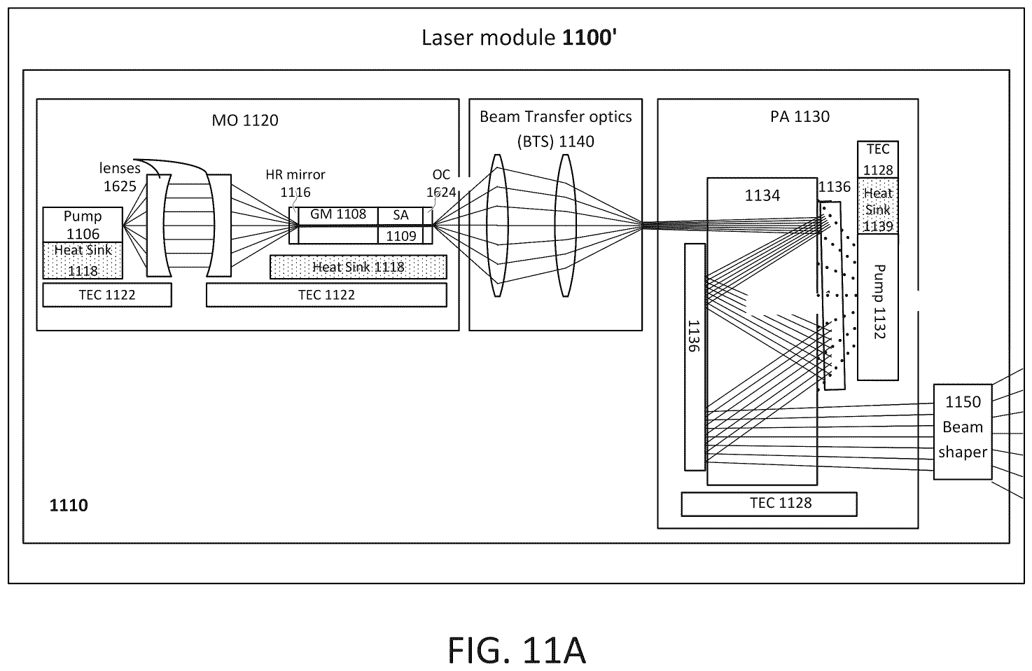

FIGS. 7 and 8 are exploded view perspective projections of gain medium amplifiers (GMAs) 700 and 800, in accordance with examples of the presently disclosed subject matter. GMA 700 includes at least flat neodymium-doped yttrium aluminum garnet (Nd:YAG) crystal 702. Crystal 702 has an average thickness of less than 5 millimeters (e.g., about 1 mm, further examples are provided below), while at least one of the other dimensions of crystal 702 are longer (e.g., at least 5 times longer), and possibly both of the perpendicular dimensions are at least 5 times longer than the average thickness of crystal 702.

Flat Nd:YAG crystal 702 includes at least:
Top surface 704 through which pump light having a first frequency (also referred to as “pump frequency”) enters the flat Nd:YAG crystal 702 (e.g., from an optional pump light source 706).
Bottom surface 708, opposing top surface 704.
First side surface 710, through which incoming laser light having a second frequency (e.g., arriving from optional seed laser 902) enters the flat Nd:YAG crystal.
Second side surface 712 through which outgoing laser light having the second frequency is emitted from the flat Nd:YAG crystal after being reflected by multiple different sides surfaces of the flat Nd:YAG crystal.

According to some embodiments of the disclosure, the power of the outgoing laser light is at least 4 times stronger than a power of the incoming laser light, after being amplified using the pump light. Stronger amplification levels may be implemented, such as at least 5, at least 7, at least 10, at least 15, at least 20, at least 30, and so on.

The flat Nd:YAG crystal may include additional side surfaces in addition to the surfaces mentioned above. Some or all of the surfaces of the flat Nd:AG crystal (optionally including one or both of the first side surface and the second side surface) may be flat or substantially flat, but this is not necessarily so, and curved surfaces may also be implemented. The light may be internally reflected within the flat Nd:YAG crystal from one or both of the first side surface and the second side surface, but this is not necessarily so. The light may be internally reflected within the flat Nd:YAG crystal from one or more surfaces other than the first side surface and the second side surface, but this is not necessarily so. The first side surface and the second side surfaces may be parallel to each other, but this is not necessarily so.

It is noted that the terms “top” and “bottom” are arbitrary terms used to identify to opposing sides, and these surfaces may be positioned in different orientations in different implementations of the disclosure. The top surface may be parallel to the bottom surface (e.g., as illustrated in the diagram), but this is not necessarily so. The first side surface may have at least one shared edge with the top surface and/or with the bottom surface, but this is not necessarily so. Additionally, the second side surface may have at least one shared edge with the top surface and/or with the bottom surface, but this is not necessarily so. It is noted that any combination of the above optional implementations may be implemented, even if not explicitly stated for reasons of brevity.

The number of times light is reflected internally within flat Nd:YAG crystal 702 before being emitted as outgoing laser light affects the gain of GMA 700, which is exponentially correlated to the distance light pass within the doped crystal. Optionally, as in GMA 800, the optical path of the incoming laser light until it is emitted as outgoing laser light includes at least 10 internal reflections 802. Different number of internal reflections may also be implemented, such as between 10-15, between 15-20, between 20-25, between 25-35, or more. Optionally, the optical path of the incoming laser light until it is emitted as outgoing laser light is at least 50 times longer than the average thickness of the flat Nd:YAG crystal. Different ratios between the optical path and the average thickness may be implemented, such as between 50-100, between 100-200, or more than 200.

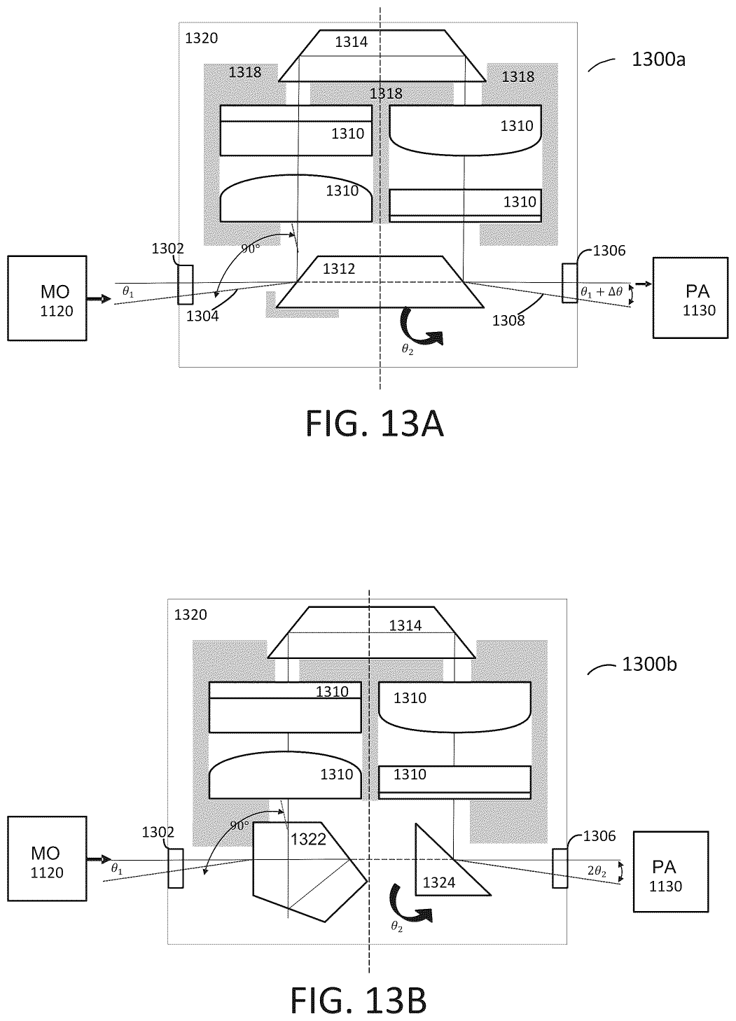

It is noted that optionally, GMA 700 may include one or more mirrors positioned in proximity to parts (or all of) at least one side surface of flat Nd:YAG crystal 702, in which case the aforementioned internal reflections may include reflections from the respective one or more mirrors associated with the respective side surfaces of flat Nd:YAG crystal 702, instead of (or in addition to) internal reflections within flat Nd:YAG crystal 702 from the respective side surfaces themselves. Examples of such additional mirrors are provided in FIGS. 11A-11C. For example, such mirrors may be positioned adjacent to first side surface 710 and/or to second side surface 712. While not necessarily so, a mirror which reflects light arriving from flat Nd:YAG crystal 702 back into flat Nd:YAG crystal 702 (at a different angle) may be parallel to the respective side surface next to which it is positioned, or slightly angled with respect thereto (e.g., in an angle of less than 1°). Such an angle between the mirrors may reduce unwanted effects such as parasitic lasing.

The flat Nd:YAG crystal may be used to amplify specific frequencies. The pump light may be of one or more pump frequencies (or pump frequency ranges). For example, the pump frequency may be between 750 nanometer ( nm) and 850 nm. For example, the pump frequency may be between 780 nm and 830 nm. For example, the pump frequency may be between 800 nm and 850 nm. For example, the pump frequency may be between 800 nm and 820 nm. For example, the pump frequency may be 808 nm±2 nm. However, other frequency ranges may be implemented. The pump light may be laser light (e.g., vertical-cavity surface-emitting laser or any other type of laser), light emitting diode (LED) light, or light of any other suitable source.

The outgoing laser light may be of one or more emitted light frequencies (or emitter frequency ranges). For example, the emitted light frequency may be between 1,300 nm and 1,400 nm. For example, the emitted light frequency may be between 1,310 nm and 1,370 nm. For example, the emitted light frequency may be between 1,330 nm and 1,350 nm. For example, the emitted light frequency may be 1,340 nm±2 nm.

The second laser frequency (also referred to as “incoming laser frequency”) may be the same frequency as the outgoing laser frequency. For example, the second light frequency may be between 1,300 nm and 1,400 nm. For example, the second light frequency may be between 1,310 nm and 1,370 nm. For example, the second light frequency may be between 1,330 nm and 1,350 nm. For example, the second light frequency may be 1,340 nm±2 nm.

Top surface 704 has a first dimension (e.g., length) and a second dimension (e.g., width) that is orthogonal to the first dimension. The first dimension is at least 5 times longer than the average thickness of the flat Nd:YAG crystal. For example, if the average thickness of the flat Nd:YAG crystal is 1 mm, the first dimension may be any length that is equal or larger to 5 mm (e.g., 5 mm, 10 mm, between 5-15 mm, between 15-25 mm, etc.). The average thickness may vary according to the application, such as smaller than 0.5 mm, between 0.5-1 mm, between 1-1.5 mm, between 1.5-2 mm, between 2-5 mm, and so on. The length of the flat Nd:YAG crystal is its largest measure along the first dimension. Optionally, the average length along the first dimension may also be at least times longer than the average thickness of the flat Nd:YAG crystal.

Optionally, flat Nd:YAG crystal 702 is a prism. Optionally, flat Nd:YAG crystal 702 is a right prism. Optionally, flat Nd:YAG crystal 702 is a right rectangular prism. Any other shape or structure may be possible. Any one or more of the aforementioned surfaces of flat Nd:YAG crystal 702 may be facets. In the example of FIG. 7, the thickness of flat Nd:YAG crystal 702 is substantially constant, and is denoted “H”. In the example of FIG. 7, the internal reflections within flat Nd:YAG crystal 702 are reflected only from first side surface 710 and from second side surface 712, but this is not necessarily so, and light may be internally reflected from any surface of flat Nd:YAG crystal 702 before being emitted as the outgoing laser light.

In addition to flat Nd:YAG crystal 702, GMA 700 may also optionally include optional pump light source 706, which emits the pump light that has at least the first frequency. Optional pump light source 706 may be implemented as suitable type of light source, such as LED, vertical-cavity surface-emitting laser (VCSEL), other types of lasers, and so on.

It is noted that utilization of VCSEL as a pump light source (which is made feasible by the disclosed novel geometrical format of the flat Nd:YAG crystal 702) may be used for reducing the cost of the crystal amplifier when compared to prior art solutions, as well as facilitating easier and high-volume manufacturing when compared to prior art solutions.

The disclosed novel geometry in which pump light is provided over a large top surface means that the light source may have a relatively low brightness per area.

Optionally, GMA 700 (or 800) is operated in a low duty cycle (e.g., below 3%, between 3%-5%, between 5%-10%), so as to allow GMA 700 to cool down (which is facilitated by the relative thinness of GMA 700. Optionally, GMA 700 may include a cooling module 720 (whether an active cooling module or a passive cooling module which may be connected to a heat sink) for cooling down flat Nd:YAG crystal 702, or any other part of GMA 700. Optionally, a surface of cooling module 720 may touch a corresponding surface of flat Nd:YAG crystal 702 (e.g., bottom surface 708, as illustrated, or any other surface of the crystal). The relative thinness of flat Nd:YAG crystal 702 also enables doping of the crystal in relatively high doping density (e.g., above 1%, between 1-2%, between 2-3%).

Optionally, GMA 700 may be a side pumped GMA which is activated in a multimode mode, with optionally tens of different modes of the illumination.

Referring to a GMA 700 (or 800) in its entirety, better extraction efficiency may be achieved in GMA 700 by the combination of the ceramic Nd:YAG crystal and a multipass of light within it (which extends the effective path).

Optionally, a doping concentration of the Neodymium within the flat Nd:YAG crystal is lower than 4%. Optionally, a doping concentration of the Neodymium within the flat Nd:YAG crystal is between 1% and 2%. Optionally, the top surface is coated with anti-reflective coating for at least one frequency out of: the first frequency, the second frequency, and the emitted light frequency.

Optionally, the top surface is coated with anti-reflective coating for at least two frequencies out of: the first frequency, the second frequency, and the emitted light frequency. Optionally, at least one of the first side surface and the second side surface is coated with anti-reflective coating for at least one frequency out of: the first frequency, the second frequency, and the emitted light frequency.

Optionally, at least one of the first side surface and the second side surface is coated with anti-reflective coating for at least two frequencies out of: the first frequency, the second frequency, and the emitted light frequency. Optionally, the at least one of the first side surface and the second side surface is further coated with anti-reflective coating for an amplified spontaneous emission (ASE) frequency of the flat Nd:YAG crystal 702 (e.g., 1,064 nm).

Optionally, light entering the flat Nd:YAG crystal via the first side surface is emitted along at least 80% of its optical path before being emitted via the second side surface.

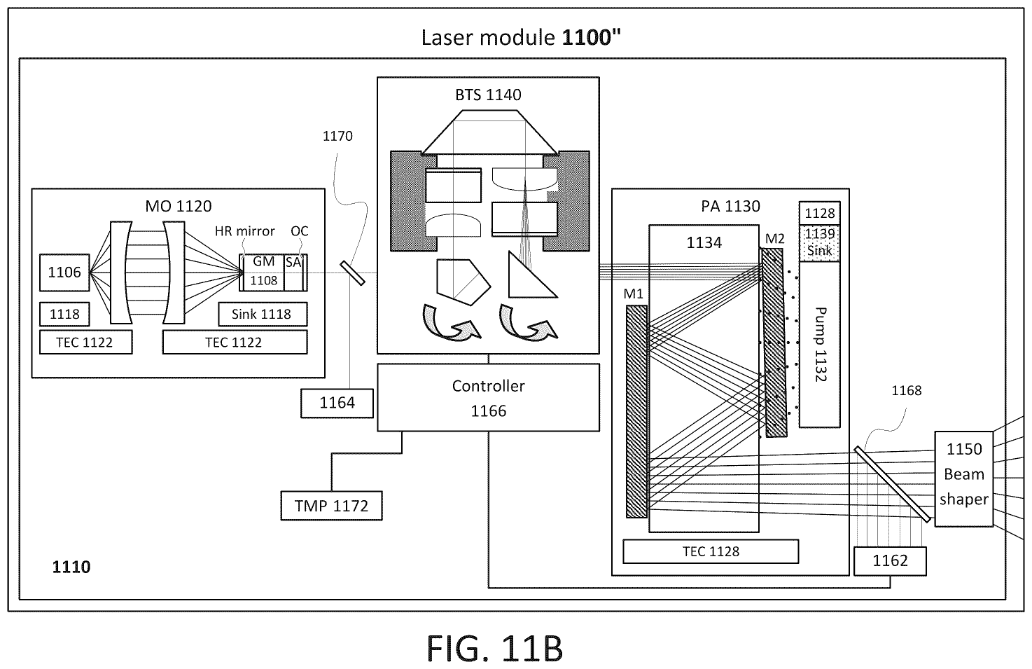

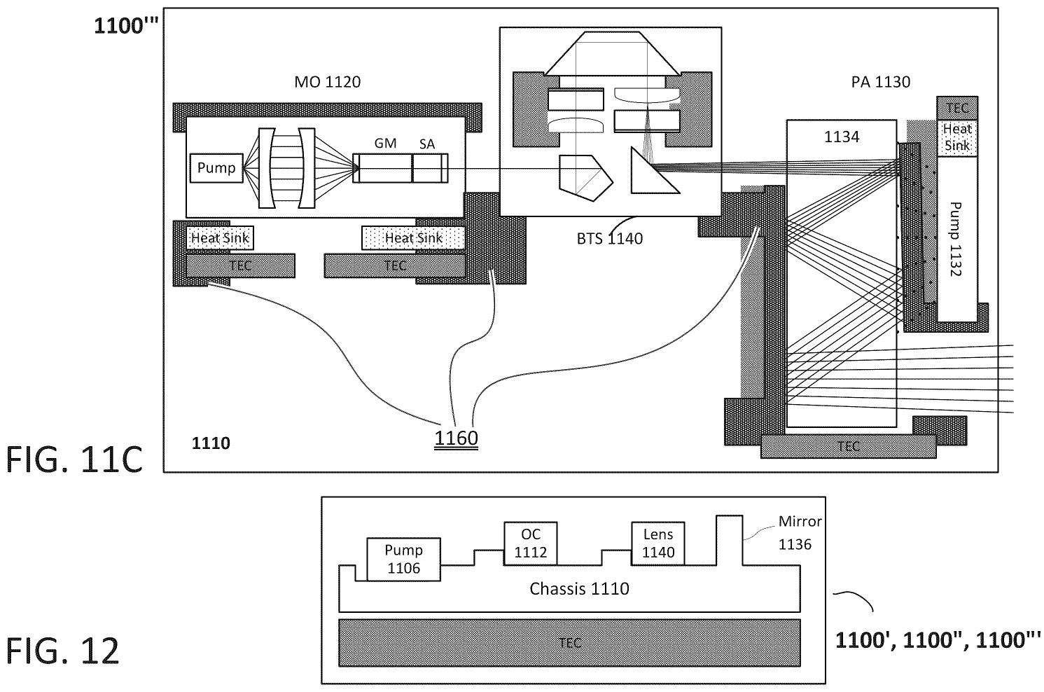

FIGS. 9 and 10 illustrate exemplary exploded view perspective projections of gain medium amplifiers and amplified laser illumination sources in accordance with examples of the presently disclosed subject matter. Amplified laser illumination sources of FIGS. 9 and 10 may include gain medium amplifier 700 and a seed laser 902. Optionally, the seed laser may be an Nd:YAG based laser emitting the light entering the flat Nd:YAG crystal via the first side surface. Optionally, any of the aforementioned lasers (e.g., the lasers discussed with respect to FIGS. 1 through 6) may be used as seed laser 902.

Optionally, flat Nd:YAG crystal 702 may be a co-doped crystal in which the YAG crystal (or at least one or more parts thereof) is doped by neodymium and further doped by an additional material. The additional material may be a material which, when doping the YAG crystal, suppresses light in at least one ASE frequency of the flat Nd:YAG crystal 702. For example, chromium (Cr), and especially chromium ions (e.g., Cr⁴⁺) may be used to suppress emission at 1,064 nm. Further doping the flat Nd:YAG crystal 702 with chromium may increase the yield of the amplifier. Other materials may also be used (e.g., Co³⁺).

Referring to implementations in which some or all of the side surfaces are not perpendicular to the top surface, it is noted that an angle between a side surface and the top surface (and/or the bottom surface) may be selected which reduces the effect of ASE, and the degree to which ASE will be amplified within the flat Nd:YAG crystal 702.

FIGS. 11A, 11B, and 11C are schematic functional block diagrams illustrating exemplary MOPA systems, in accordance with the presently disclosed subject matter. Laser modules 1100′, 1100″ and 1100″′ may be considered “consolidated” MOPA laser modules in that it is assembled from a plurality of components which may be attached to a single chassis, frame, skeleton, base or structure so as to be combined into a single rigid unit.

A MOPA laser module like modules 1100′, 1100″ and 1100″′ includes at least the following components:
a. a prefabricated chassis 1110, which includes a plurality of surfaces (e.g., holes, grooves, perturbances, pins, ridges, bulges, etc.) to which other parts of a MOPA laser module may be attached, connected, fixed or fastened. Prefabricated chassis 1110 may be manufactured as a single monolithic unit (e.g., using casting, milling, or any other suitable process), or as a plurality of parts or elements which are enduringly affixed to one another (e.g., using gluing, welding, bonding, or any other suitable process). Prefabricated chassis 1110 may also be considered as a rigid frame to which other components are affixed, if manufactured in a frame-like shape. Chassis 1110 (also referred to as “monolithic assembly”) may consist of one or several machined materials that are in contact to each other with high accuracy. Optionally, chassis 1110 may be made of high-grade material. Optionally, chassis 1110 may be made of one or more materials having low temperature expansion. Optionally, chassis 1110 may be made of suitable material(s) and optionally have a shape which is designed to diminish and compensate for acoustic or vibration noises.
The monolithic assembly may consist of a plurality of polished surfaces, to provide a plurality of parallel polished surfaces, comprising at least a first polished surface and a second polished surface. This will allow all add-on elements to be aligned to each other in a manner that angular shifts (e.g., parallelism, perpendicularity), displacements or any other dimensional tolerances are defined by the monolith accuracy where possible in order to reduce or avoid use of alignment tools and testing equipment. Thus a monolithic assembly may reduce costs, assembly time, qualification and verification phases;
b. a master oscillator (MO) laser (or simply “MO”) 1120, enduringly affixed to at least one first surface out of the plurality of surfaces, places, spaces, locations, spots, or positions of chassis 1110. Optionally, MO 1120 may be a passive Q-switched laser, such as any one of the Q-switched lasers discussed above (e.g., Q-switched laser 200 of FIG. 1), or any other suitable laser. While not necessarily so, MO laser 1120 may be a SWIR laser. MO laser 1120 may include, for example, a pump 1106, a GM 1108, a SA 1109, an output coupler (OC) 1112, focusing lenses 1114, a mirror 1116, one or more heat sinks 1118 and one or more thermoelectric coolers (TECs) 1122. Any other elements, modules or objects may be included in MO laser 1120;
c. a power amplifier (PA) 1130, enduringly affixed to at least one second surface out of the plurality of surfaces, places, spaces, locations, spots, or positions of chassis 1110. Optionally, PA 1130 may be a GMA, such as any one of the gain-medium amplifiers discussed above, or any other suitable PA. While not necessarily so, PA 1130 may be a SWIR PA. Different amplification levels may be implemented, based on the specific use to which a MOPA laser module is designed for, such as ×2, ×5, ×10, ×25 amplification, or any other amplification level. PA 1130 includes at least one pump 1132, a flat crystal 1134, mirrors 1136, TECs 1128 and heat sinks 1139. Any other elements, modules or objects may be included in PA 1130;
d. a beam transfer system (BTS) 1140, enduringly affixed to the prefabricated chassis 1110 (e.g., to at least one third surface out of the plurality of surfaces of chassis 1110). BTS 1140 includes at least a plurality of optical elements which are together operable to transfer light outputted from MO 1120 to PA 1130, for amplification (possibly after beam manipulation, or any other optical manipulation of the transferred light).

While not necessarily so, a MOPA laser module may include a beam shaper 1150 for shaping the beam of light output by PA 1130.

An “enduring affixing” in the context of the present disclosure pertains to a long-lasting affixing, fixing, attaching, fastening or pinning without significant alteration. The enduring affixing may be a direct affixing (e.g., by pressing two objects one toward the other without any intermediate component), affixing using an affixing medium such as glue, screw, etc., indirect affixing (e.g., via a spacer or a bracket), and so on. The enduring affixing is a rigid affixing, but it may optionally be a controllably modifiable affixing. For example, two objects of a MOPA laser module may be enduringly affixed to one another by an intermediate mechanical coupler whose dimensions and/or position may be controllably altered by a controller (e.g., by changing a magnitude of electric current provided to the intermediate mechanical coupler).

The alignment between the plurality of components of MOPA laser module 1100′, 1100″ or 1100″′ is primarily determined by the spatial relationship between the plurality of surfaces of prefabricated chassis 1110 and/or between elements or objects affixed to plurality of surfaces. For example, a spatial relationship between the at least one first surface and the at least one second surface determines an alignment between MO 1120 and PA 1130. For example, as illustrated in FIG. 11C MOPA laser module 1100″′ may include a plurality of parts or surfaces of the chassis (denoted 1160), each part or surface may extend out of a plane of the chassis next to it, or may be a hole or a groove deeper than a plane of the chassis surrounding it, or may be at the same height of a plane of the chassis surrounding it. It should be understood to a person skilled in the art that each part or surface of chassis 1160, may have a height which may be equal or different from height of another part or surface of chassis 1160. It is noted that some of, for example, a first, a second, and a third surfaces may be parts of flat surfaces of the chassis. For example, in the assembly process, the location of some components of MOPA laser module 1100″′ may be determined by pressing the respective component against a protrusion but gluing it to the flat surface of the chassis 1110 beneath the object.

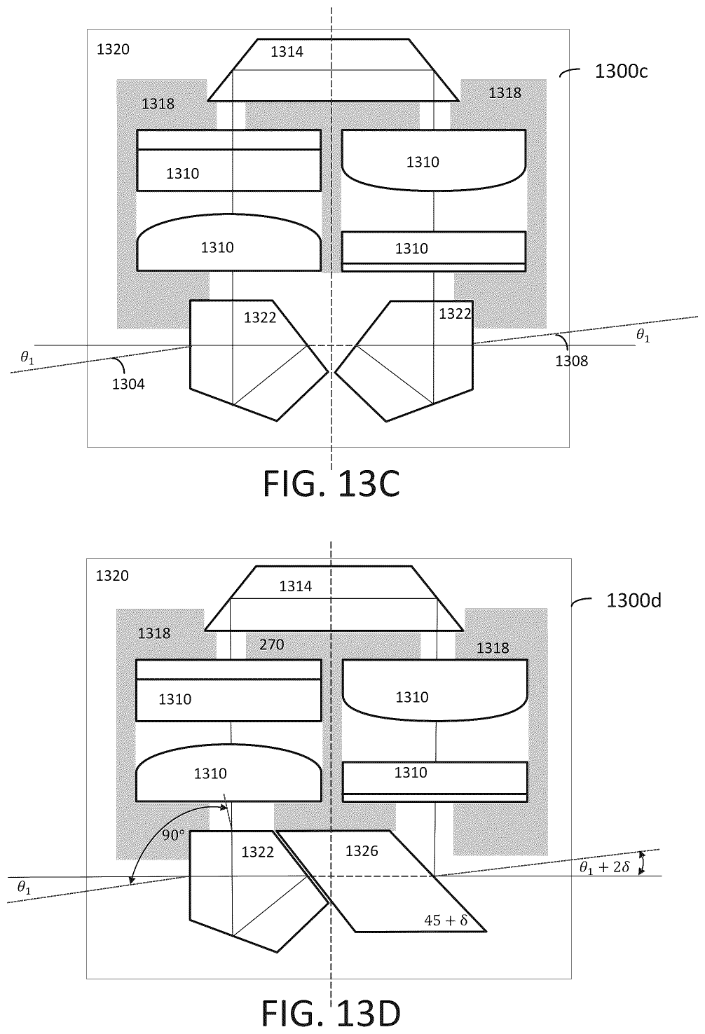

FIG. 12 is a side view illustrating exemplary components of MOPA laser module and chassis, in accordance with the presently disclosed subject matter. The MOPA laser module may be for example any of module 1100′, 1100″ or 1100″′. The FIG. 12 side view shows how different components of a MOPA laser module may be connected to chassis 1110. It should be understood that any element, component or device may be connected or affixed to chassis 1110. In the illustrated example, a pump , e.g., pump 1106 of FIG. 11C is positioned within a dedicated hole or groove, an OC, e.g., OC 1112 of FIG. 11C and a lens, e.g., of BTS 1140 of FIG. 11C are positioned against protrusions in the surface of chassis 1110. According to embodiments, one or more elements, components may be formed integrally in chassis 1110. For example, a mirror of PA 1130 (e.g. one of mirrors 1136) is made from a protrusion of chassis 1110, which is polished to include a highly reflective surface which can serve as a mirror 1136.

For example, if PA 1130 includes at least one pump and a flat crystal 1134 (e.g., having an average thickness of less than 20 millimeters) which is pumped by the pump, such that light of MO 1120 that is passed through the crystal 1134 in multiple passes is being amplified in each of the multiple passes using energy of the pump, chassis 1110 may optionally include at least one polished surface which serves as a mirror 1136, reflecting light from the flat crystal back into the crystal 1134 at least once. Such a mirror surface may be integral to chassis 1110, made form the same material, cast together, and so on.

Optionally, affixing both MO 1120 and PA 1130 to the same chassis 1110 (e.g., the same rigid plate) may be used for aligning crucial surfaces such that a plurality of surfaces may be aligned to each other with minimum tolerances. Crucial surfaces are surfaces of parts of a MOPA laser module whose spatial relationship require high accuracy in order to provide quality optical output. Such crucial surfaces may include, for example, planes of mirror, axes of lenses, position of prisms, and so on. Enduringly affixing such component to the chassis 1110 (either directly or indirectly, e.g., as discussed in further details below) may also be used for maintaining the alignment between these components for long periods of time, in harsh environment and/or in varying conditions (e.g., temperatures, humidity).

Including the plurality of surfaces as part of chassis 1110 (especially if polished prior to the affixing of the components to the chassis) may be used for aligning such add-on components with respect to one other in a manner that angular shifts (e.g., parallelism, perpendicularity), displacements or any other dimensional tolerances are defined by the accuracy to which the chassis can be manufactured and processed, where possible.

In some embodiments of the disclosure, a MOPA laser module may include one or more TECs, (e.g., TECs 1122, TECs 1128 of FIG. 11A) which are positioned where cooling is needed (e.g., as exemplified in the diagrams). Optionally, such one or more TECs may be embedded in chassis 1110 to allow active temperature control of the entire chassis 1110 or separate areas or modules within chassis 1110. Optionally, at least one part of chassis 1110 is a part of a TEC which is operable to cool at least one of MO 1120 and PA 1130.

Optionally, a MOPA laser module like 1100′, 1100″ or 1100″′ may include at least one lens and folding optics (e.g., as part of BTS 1140), wherein an optical axis of light outputted by MO 1120 continues to a location on an entry location on a side surface of PA 1130, such that light entering PA 1130 along the optical axis is amplified and emitted at an output optical axis of PA 1130. That is, even when BTS 1140 is not assembled, an alignment between MO 1120 and PA 1130 may be verified (at least to some degree) by measuring an output of the PA 1130 when its optical entry window is being directly illuminated by MO 1120. Optionally, BTS 1140 maintains this optical axis. Optionally, a position of BTS 1140 with respect to chassis 1110 is such that light enters BTS 1140 and leaves BTS 1140 along the aforementioned optical axis, after being deflected by the folding optics and manipulated by the at least one lens. Optionally, BTS 1140 may be part of chassis 1110, e.g., integrated with chassis 1110 such that all the optical elements of BTS 1140 are directly attached, glued or fixed to the chassis 1110 while no additional components in between, this will increase tolerances and lower costs.

Optionally, a MOPA laser module like 1100′, 1100″ or 1100″′ may be a SWIR MOPA laser module, in which:
a. a frequency of a pump source of the MO is between 750 nanometer (nm) and 850 nm;
b. a frequency of light emitted by the MO is between 1,300 nm and 1,400 nm;
c. a frequency of a pump source of the PA is between 750 nanometer (nm) and 850 nm;
d. a frequency of light emitted by PA is between 1,300 nm and 1,400 nm;
e. a gain medium of the MO includes crystalline material which is neodymium-doped yttrium aluminum garnet (Nd:YAG) (either ceramic or not);
f. a saturable absorber of the MO includes crystalline material (either ceramic or not) selected from a group of doped ceramic materials consisting of: (a) three-valence vanadium-doped yttrium aluminum garnet (V³⁺:YAG) and (b) two-valence Cobalt-doped crystalline materials; and
g. the PA includes a flat Nd:YAG crystal.

The disclosed designs of a MOPA laser module like 1100′, 1100″ or 1100″′ may be preferred over different prior art solutions (such as fiber-coupled power amplifiers) in that it requires a minimal number of elements, alignment tooling and testing equipment, thus reducing costs, assembly time, qualification and verification phases. For example, master oscillator fiber amplifiers (MOFAs) require accurate and highly efficient coupling from a (solid-state) laser to a single/multi-mode fiber. In case of a high-power source, the spatial shape of the laser is not a simple TEM00 mode, which makes coupling very challenging, requiring complex beam-shaping optics, precision micro-positioning and active/passive stabilizers. In contrast, the presented designs are less sensitive (e.g., insensitive) to these aspects and are inherently precise. Thus, it reduces costs, assembly time, qualification and verification phases.

MO 1120 may include any combination of one or more of the following components:
a. Pump source (e.g., at 808 nm);
b. Pump beam shaping lens;
c. Active material (e.g., consisting of Nd:YAG);
d. Saturable absorber (e.g., consisting of V:YAG);
e. Output coupler (OC);
f. Heat sinks;
g. TECs.

Beam transfer system (BTS) 1140 may include any combination of one or more

of the following components:
a. Lenses;
b. Folding elements (mirrors, prisms).

Power Amplifier (PA) 1130 may include any combination of one or more of the following components:
a. Mirror 1 (e.g., M1 of FIG. 11B);
b. Mirror 2 (e.g., M2 of FIG. 11B);
c. Active material (Slab, e.g., made of Nd:YAG);
d. Pump source (e.g., at 808 nm);
e. Pump beam shaping lens;
f. Heat sinks;
g. TECs.

Referring to any pump of a MOPA laser module like 1100′, 1100″ or 1100″′ it is noted that either end-pumping or side-pumping may be implemented for MO 1120 and/or for PA 1130, and that the pumps may be positioned in any suitable direction with respect to the associated crystal.

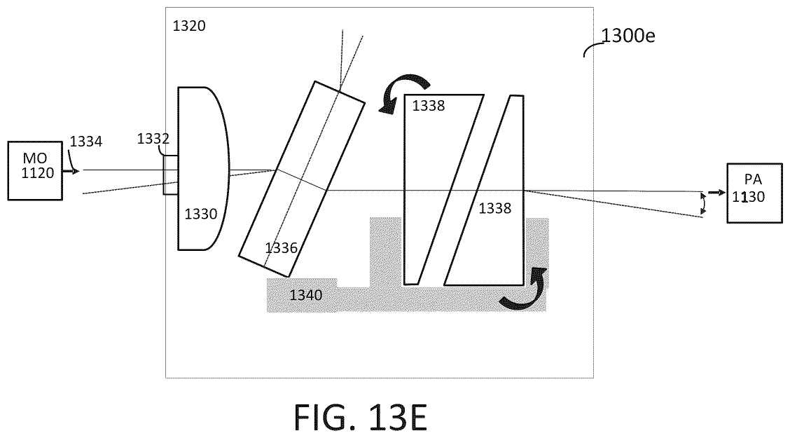

Reference is made now to FIGS. 13A-13E which illustrate a BTS like BTS 1140, in accordance with examples of the presently disclosed subject matter. For convenience, these example BTSs are numbered 1300a, 1300b, 1300c, 1300d and 1300e. The BTSs of FIGS. 13A-13E may be used as BTS 1140 of the MOPA laser module, but are not limited to use in such MOPA laser modules, and may be used in any suitable MOPA laser module. The BTS may include a chassis 1320 like any chassis of FIGS. 11A-11C.

Referring by way of example only to the illustrated examples of FIGS. 13A-13D, a BTS for a MOPA laser module is disclosed, which includes at least:
a. an optical entrance 1302, for receiving a light beam of MO laser module 1120 along an entry optical axis 1304;
b. an optical egress, or exit 1306, for emitting a manipulated light beam towards a PA 1130 along an egress optical axis 1308;
c. A plurality of lenses 1310 (e.g., aspheric lenses, cylindrical lenses), at least one of which is shaped for manipulating the light beam and for fitting to at least one dedicated three-dimensional (3D) structure of a chassis. The fitting of the at least one lens to the respective dedicated 3D structure may be a direct fitting, or fitting using one or more dedicated intermediary mechanical components (e.g., spacers, brackets).
d. Folding optics 1312 and 1314 including a plurality of folding optical components including at least one type of components selected from a group consisting of mirrors, e.g., mirror 1312, and prisms, e.g., prism 1314. The folding optics (1312, 1314) may be operable to deflect light entering the BTS along the entry optical axis 1304 towards at least one lens of the plurality of lenses 1310, and to deflect light arriving from at least one other lens of the plurality of lens 1310 toward the egress optical axis 1308, wherein at least one of the folding optical components is shaped for manipulating the light beam and for fitting to at least one customized 3D structure of the chassis 1320. The fitting of the at least one folding optical component to the respective customized 3D structure may be a direct fitting, or fitting using one or more dedicated intermediary mechanical components (e.g., spacers, brackets). It is noted that the term “customized 3D structure” is intended to carry the same meaning as “dedicated 3D structure”, and the different terms are used for differentiation between 3D structures intended for lenses to 3D structures intended for folding optical components (e.g., mirrors, prisms).

Optionally, the BTS may further include at least a portion of chassis 1320 which includes the at least one dedicated 3D structure and the at least one customized 3D structure. Optionally, the BTS may further include mechanical connectors (e.g., spacers, brackets, adhesive, screws, bolts, pins, welding) which connect components (e.g., lenses, mirrors, prisms) to the respective 3D structure of the chassis, such that all of the lenses and folding optical components of the BTS are aligned, and operable to transfer a light beam from the entrance to the egress via the plurality of lenses.

In such a case, the chassis may be made of a single material, with a single accurate machined surface in which several extremely accurate pre-defined areas 1318 which may include grooves, slits, slots, protrusions, bumps, trenches or any other shape or construction in chassis 1320. Areas or regions 1318 may be used as alignment basis 3D structures for all the optical elements. Other types of 3D structures may also be used.

Optionally, at least one of the folding optical components, e.g., 1312, 1314 is controllably movable by at least one other component of the BTS, for adjusting a position of the respective folding optical component, e.g., 1312, 1314 to the respective customized 3D structure.

Referring to FIG. 13B, optionally, at least one of the folding optical components is a pentaprism 1322 having four active surfaces, operable to internally reflect the light beam inside pentaprism 1322 twice before emitting the light beam out of pentaprism 1322.

Optionally, at least one of the folding optical components is a retroreflector having, e.g., 1314, at least three active sides, operable to internally reflect the light beam inside the retroreflector twice before emitting the light beam out of the retroreflector. The retroreflector, e.g., 1314, pentaprism 1322 and other components, may be used to align beam angularly, e.g., by rotating the retroreflector in a plurality of directions, or linearly, by translating it in a plurality of directions.

The usage of pentaprism 1322 and/or retroreflector 1314 as in FIGS. 13B-13D allows for a wider tolerance range to angular placement of the BTS. This is since elements 1322 and 1314 do not introduce beam angular shift when rotated about their axis.

In some embodiments, the exit optical axis may by a continuation of the entry optical axis as a BTS like 1300a, 1300b, 1300c, 1300d and 1300e may not affect the optical axis of the beam from MO 1120 to PA 1130. Optionally, the direction of a light beam outputted from the BTS may be controllably rotated so that it enters PA 1130 in an optimal angle to allow maximum gain. In such cases, the angle of the output light beam may be controllably modifying using any combination of one or more of the following:
a. rotating the entire BTS (e.g., possible only in some of the illustrated examples but not in others);
b. rotating some or one of the elements. For example, a rotating mirror 1324 in the example of FIG. 13B or parallelogram 1326 in the example of FIG. 13D; or
c. rotating of either MO 1120 or PA 1130. Rotating PA 1130 may be done through the introduction of an angle to a surface or surfaces that MO 1120 and/or PA 1130 are aligned against.

Referring to the example of FIG. 13C, two pentaprisms 1322 may be used as the entrance and exit deflecting optical components, and an optional retroreflector may be used for a 180 degrees rotation (more complex optical paths within the BTS may also be implemented, changing direction of the beam five times or more). Using two pentaprisms may allow minimal angular rotation of a BTS while each of the components of the BTS may be rotated in the assembly process. In the example of FIG. 13C an orientation of pentaprisms 1322 may be placed in a certain orientation, however, any other orientation may be used and pentaprisms 1322 may be placed, for example, in a perpendicular orientation, allowing for alignment or passive maintenance of high tolerances.

Referring to the example of FIG. 13D a parallelogram 1326 may be coated with a reflective coating. It is placed in a fixed position and rests on the entrance pentaprism 1322 to allow optimal angular positioning. The angle of one of parallelogram 1326 faces (or of the entire parallelogram) may determine the rotation angle (of the output beam.

Referring to the exemplary BTS 1320 of FIG. 13E, a focusing lens 1330 may be placed at an entrance 1332 of the BTS and may focus a light beam 1334 entering the BTS from MO 1120. A plate 1336 may be placed after focusing lens 1330, namely along the path of light beam 1334 from MO 1120 to PA 1130. A pre-defined angle of plate 1336 may create a shift in beam 1334 position which may be used to direct and align beam 1334 into PA 1130 with maximum transmission. In addition, a wedged prism pair 1338 placed after 1336 (along the path of light beam 1334 from MO 1120 to PA 1130) may control the titling of beam 1334 in two directions relative to beam 1334 original direction, e.g., from MO 1120. In the exemplary BTS 1320 of FIG. 13E, all elements including MO 1120, PA 1130, focusing lens 1330, plate 1336 and prism pair 1338, are placed in a single line against common walls of the chassis 1340, thus minimizing the degree of freedoms and reducing tolerance accumulation significantly. Any other lenses, prisms, plates or other optical elements may be placed in a single line against common walls of the chassis 1340 and may be used for minimizing the degree of freedom and reducing tolerance accumulation.

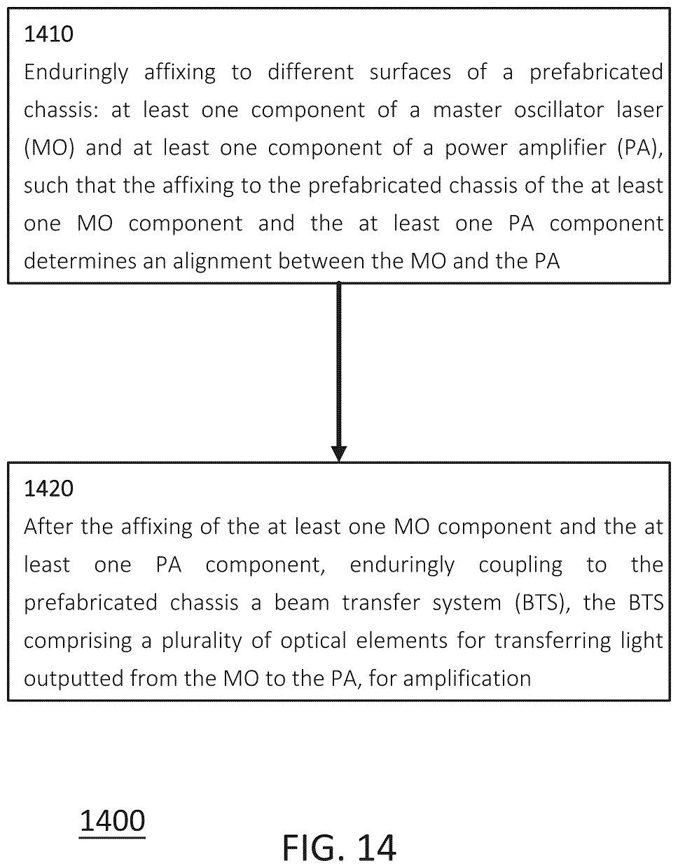

FIG. 14 is a flow chart of an example process for a method of manufacturing a consolidated MOPA laser module according to some implementation of the presently disclosed subject matter. Referring to the examples set forth with respect to the previous drawings, method 1400 may be used, for example, for manufacturing a MOPA laser module of FIGS. 11A-11C. All elements described in FIG. 14 may be, for example, elements of described with reference to a MOPA laser module of FIGS. 11A-11C.

Method 1400 includes at least the following stages:
Stage 1410 of enduringly affixing or attaching to different surfaces of a prefabricated chassis: at least one component of MO, e.g., MO 1120 of FIG. 11A and at least one component of the PA e.g., MO 1120 of FIG. 11A, such that wherein the affixing to the prefabricated chassis of the at least one MO component and the at least one PA component determines an pre-defined alignment between the MO and the PA. For example, MO 1120 may be enduringly affixed to at least one first surface out of the plurality of surfaces of chassis 1110 of FIG. 11C. PA 1130 may be enduringly affixed to at least one second surface out of the plurality of surfaces of chassis 1110 of FIG. 11C. A spatial relationship between the at least one first surface and the at least one second surface may determine an alignment between the MO and the PA.
Stage 1420 which may be executed after stage 1410 may include enduringly coupling or affixing a BTS to the prefabricated chassis. The BTS may be attached or affixed to at least one third surface out of the plurality of surfaces of chassis 1110. The BTS may include a plurality of optical elements for transferring light outputted from the MO to the PA, for amplification. Referring to the examples set forth with respect to the previous drawings, the BTS of stage 1420 may be BTS 1140 of FIGS. 11A-11C and/or any variation of the BTSs 1320 discussed with respect to FIGS. 13A-13E.

It is noted that fine-tuning and/or further aligning of the components of the MO and/or of the PA may be executed after some or all of the components of the BTS are positioned and affixed to the chassis.

Optionally, the affixing may include directing or illuminating the MO directly towards the PA, sensing an output of the PA resulting from the illumination, adjusting an alignment between the MO and the PA based on results of the sensing, and affixing at least one component of at least one of the MO and the PA based on the adjusted alignment.

Optionally, the method 1400 may further include measuring output of the PA at two or more different temperatures and at two or more different states of at least one controllable optical component (COC) of the BTS, computing temperature compensation information for the at least one COC, and storing the temperature correction information at a tangible memory module which is readable by a controller that is operable to modify a state of the at least one COC.

Optionally, the method 1400 may further include measuring output of the PA at two or more different temperatures and at two or more different states of at least one thermoelectric cooler (TEC) of MOPA laser module, computing temperature compensation information for the at least one TEC, and storing the temperature correction information at a tangible memory module which is readable by a controller that is operable to modify a state of the at least one TEC.

Optionally, the method 1400 may further include measuring output of the PA at two or more different temperatures and at two or more different states of at least one pump of the MO or the PA, computing temperature compensation information for the at least one pump, and storing the temperature correction information at a tangible memory module which is readable by a controller that is operable to modify a state of the at least one pump.

Optionally, the enduringly affixing may be preceded by polishing at least one first surface and at least one second surface of the chassis to be parallel to one another, wherein the enduringly affixing including enduringly affixing the at least one component of the MO to the first surface and enduringly affixing the at least one component of the PA to the second surface.

Referring to stage 1420 and to some of the optional implementation of a MOPA laser module, the BTS assembly is separate and done only after MO and PA are already aligned (up-to incidence angle to the PA). a plurality of methods for accurate positioning of different elements may be used. These methods may be used for any instance of item positioning and/or affixing discussed in the present disclosure:
a. Alignment invariancy to rotations—using accurate prisms (e.g. Pentaprisms, Dove, Retroreflector) instead of regular mirrors will allow accurate assembly with no change in angular tolerance.
b. Placement of sub-assemblies, such as the BTS, will not affect system alignment.
c. Assembly procedure (e.g., as in FIG. 13A) is similar to the assembly process discussed with respect to the entire MOPA laser module.

After completion of the previous steps, final tests and alignment process may optionally begin. This process may be aimed to achieve at least one of the following:
a. Alignment and testing of the MOPA laser module for optimal output gain and output beam shape.
b. Testing performance at full temperature range and full TEC range. Measurements taken at different temperatures may be used to control the operation of various components of the MOPA laser module by a controller during the lifetime of the MOPA laser module, e.g., as discussed elsewhere in this disclosure.

Method 1400 may optionally include any one or more of the following optional stages:
a. Attach (e.g., gluing) at least one MO component (e.g., Output coupler) to one polished surface of the chassis, such that they are parallel. The attachment may be a direct connection or an indirect connection (e.g., via the chassis, a bracket, a spacer, and so on).
b. Attach at least one PA component (e.g., mirror) to at least one MO component such that they are also parallel. The attachment may be a direct connection or an indirect connection (e.g., via the chassis, a bracket, a spacer, and so on).
c. As a different option to (a) and (b) or together with (a) and/or (b), the assembly may include using assembly tools for alignment (e.g., spacers, brackets, micro-positioners, autocollimators, and the like) of the surfaces in (a) and (b) or different surfaces to achieve high accuracy of alignment (angular and/or positional)
d. Additional elements may be assembled in a similar manner to steps a-c, until MO and PA sub-modules are assembled. It is noted that some components of the MO and/or of the PA may be connected to one another before being connected to the cassis (e.g., as discussed with respect to the manufacturing of the P-QS laser of FIG. 1).
e. After all elements are in place, optical alignments and testing may be carried out, for ensuring the assembly is within specifications. Optional goals for these tests may be to achieve one or more of:
   i. Optimal beam quality at MO exit (energy, beam and pulse shape etc.).
   ii. Optimal alignment of MO to PA—entrance angle and location.
f. Following stage 1420, alignment of the PA entrance angle and other parameters may be carried out, in order to optimize gain of the MOPA laser module.

In case one of one or more of the tests carried out during the manufacturing (or later in the lifetime of the MOPA laser) malfunctions, the system may include a controller which is able to correct itself by modifying TEC current, pump power, etc.

Reverting to the discussion of a MOPA laser module like modules 1100′, 1100″ or 1100″′ (e.g., pertaining to FIGS. 11A-11C), it is noted that optionally a MOPA laser module may include an least one intermediate mechanical coupling endurably affixed between a component of the MO or the PA and a corresponding surface of the chassis, wherein a degree of dislocation provided by the intermediate mechanical coupling and the corresponding surface is determined based on optical measurement of light emitted by the MO. Such a mechanical coupling may be controlled by the controller during operational period of the MOPA laser module, but this is not necessarily so, and optionally the degree of dislocation may be determined during manufacturing of the MOPA laser module, in ways which are not modifiable by the controller. For example, as a result of measurements of light intensity (or other optical parameters) executed during the manufacturing of the MOPA laser module, method 1400 may include selecting one of multiple optional mechanical couplers of different dimensions (e.g., spacers of different widths, brackets having different angles, and so on).

Reference is made back to FIG. 11B. MOPA laser module 1100″ may optionally include one or more internal optical sensor e.g., sensor 1162, and/or sensor 1164 for measuring a sensed intensity indicative of an intensity of an internal light beam emitted by at least one of MO 1120 and PA 1130, and a controller 1166 operable to trigger movement of at least one optical component of the MOPA laser module, for increasing the intensity of the internal light beam. One or more beam splitters 1168, 1170 may be included to directing light of the light beam towards the relevant internal optical sensors (which may be, for example, photodiodes).

Optionally, MOPA laser module 1100″ may include one or more internal temperature sensor 1172 for measuring a temperature sensed within the MOPA laser module. According to some embodiments of the disclosure, controller 1166 may be operable to trigger movement of at least one optical component of the MOPA laser module based on the measured temperature. For example, based on the temperature measured by temperature sensor 1172 and/or on temperature correction information stored in a tangible memory module accessible by the controller (directly or indirectly).

Optionally, MOPA laser module 1100″ may include one or more internal optical sensors (e.g., 1162 and 1164) for measuring a sensed intensity indicative of an intensity of an internal light beam emitted by at least one of the MO and the PA, and a controller (e.g., 1166) operable to trigger modification of an electric magnitude of a controlled component of the MOPA laser module (e.g., TEC, pump ), for increasing the intensity of the internal light beam. Beam splitters (e.g., 1168, 1170) may be included to directing light of the light beam towards the relevant internal optical sensors (which may be, for example, photodiodes).

Optionally, MOPA laser module 1100″ may include one or more internal temperature sensor 1172 for measuring a temperature sensed within the MOPA laser module, and a controller (e.g., 1166) operable to trigger modification of an electric magnitude of a controlled component of the MOPA laser module based on the measured temperature, e.g. measured by sensor 1172. In some embodiments, controller (e.g., 1166) may be operable to trigger modification of an electric magnitude of a controlled component of the MOPA laser module based on the measured temperature and/or on temperature correction information stored in a tangible memory module accessible by the controller (directly or indirectly).

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to disclosures containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure. It will be appreciated that the embodiments described above are cited by way of example, and various features thereof and combinations of these features can be varied and modified. While various embodiments have been shown and described, it will be understood that there is no intent to limit the disclosure by such disclosure, but rather, it is intended to cover all modifications and alternate constructions falling within the scope of the disclosure, as defined in the appended claims.

What is claimed is:

1. A consolidated Master Oscillator Power Amplifier (MOPA) laser module, the consolidated laser module comprising:
a prefabricated chassis, comprising a plurality of surfaces;
a master oscillator laser (MO), enduringly affixed to at least one first surface out of the plurality of surfaces;
a power amplifier (PA), enduringly affixed to at least one second surface out of the plurality of surfaces, wherein a spatial relationship between the at least one first surface and the at least one second surface determines an alignment between the MO and the PA; and
a beam transfer system (BTS), enduringly affixed to the prefabricated chassis, the BTS comprising a plurality of optical elements for transferring light outputted from the MO to the PA for amplification.

2. The consolidated MOPA laser module according to claim 1, wherein the MO is a passively Q-switched (P-QS) laser.

3. The consolidated MOPA laser module according to claim 1, wherein the MO comprises a crystalline saturable absorber rigidly coupled to a crystalline gain medium of the MO.

4. The consolidated MOPA laser module according to claim 3, wherein the MO further comprises a high reflectivity mirror and an output coupler rigidly coupled to the gain medium and the saturable absorber, such that the MO is a monolithic microchip P-QS laser.

5. The consolidated MOPA laser module according to claim 1, wherein the at least one first surface and the at least one second surfaces are polished surfaces parallel to one another.

6. The consolidated MOPA laser module according to claim 1, wherein the amplifier comprises:
at least one pump; and
a flat crystal having an average thickness of less than 20 millimeters which is pumped by the pump, wherein light of the MO is passed through the flat crystal in multiple passes, being amplified in each of the multiple passes,
and wherein the chassis comprises at least one polished surface which serves as a mirror, reflecting light from the flat crystal back into the flat crystal at least once.

7. The consolidated MOPA laser module according to claim 1, comprising at least one lens and folding optics, wherein an optical axis of light outputted by the MO continues to a an entry location on a side surface of the PA, such that light entering the PA along the optical axis is amplified and emitted at an output optical axis of the amplifier, and
wherein a position of the BTS with respect to the chassis is such that light enters the BTS and leaves the BTS along the optical axis, after being deflected by the folding optics and being manipulated by the at least one lens.

8. The consolidated MOPA laser module according to claim 1, wherein:
a frequency of a pump source of the MO is between 750 nanometer (nm) and 850 nm,
a frequency of light emitted by the MO is between 1,300 nm and 1,400 nm,
a frequency of a pump source of the PA is between 750 nanometer (nm) and 850 nm,
a frequency of light emitted by PA is between 1,300 nm and 1,400 nm,
a gain medium of the MO comprises crystalline material which is neodymium-doped yttrium aluminum garnet (Nd:YAG),
a saturable absorber of the MO comprises crystalline material selected from a group of doped ceramic materials consisting of: (a) three-valence vanadium-doped yttrium aluminum garnet (V³⁺:YAG) and (b) two-valence Cobalt-doped crystalline materials, and wherein
the PA comprises a flat Nd:YAG crystal.

9. The consolidated MOPA laser module according to claim 1, wherein at least one part of the chassis is a part of a thermoelectric cooler (TEC) which is operable to cool at least one of the MO and the PA.

10. The consolidated MOPA laser module according to claim 1, further comprising an intermediate mechanical coupling endurably affixed between a component of the MO or the PA and a corresponding surface of the chassis, and wherein a degree of dislocation provided by the intermediate mechanical coupling and the corresponding surface is determined based on optical measurement of light emitted by the MO.

11. The consolidated MOPA laser module according to claim 1, comprising an internal optical sensor for measuring a sensed intensity indicative of an intensity of an internal light beam emitted by at least one of the MO and the PA, and a controller operable to trigger movement of at least one optical component of the MOPA laser module, for increasing the intensity of the internal light beam.

12. The consolidated MOPA laser module according to claim 1, comprising an internal temperature sensor for measuring a temperature sensed within the MOPA laser module, and a controller operable to trigger movement of at least one optical component of the MOPA laser module based on the measured temperature.

13. The consolidated MOPA laser module according to claim 1, comprising an internal optical sensor for measuring a sensed intensity indicative of an intensity of an internal light beam emitted by at least one of the MO and the PA, and a controller operable to trigger modification of an electric magnitude of a controlled component of the MOPA laser module for increasing the intensity of the internal light beam.

14. The consolidated MOPA laser module according to claim 1, comprising an internal temperature sensor for measuring a temperature sensed within the MOPA laser module, and a controller operable to trigger modification of an electric magnitude of a controlled component of the MOPA laser module based on the measured temperature.

15. The consolidated MOPA laser module according to claim 1, wherein the BTS comprises:
an optical entrance, for receiving a light beam of a MO laser module along an entry optical axis;
an optical egress, for emitting a manipulated light beam towards the PA along an egress optical axis;
a plurality of lenses, at least one of which is shaped for manipulating the light beam and for fitting to at least one dedicated three-dimensional (3D) structure of a chassis; and
folding optics comprising a plurality of folding optical components comprising at least one type of components selected from a group consisting of mirrors and prisms, the folding optics operable to deflect light entering the BTS along the entry optical axis towards at least one lens of the plurality of lenses, and to deflect light arriving from at least one other lens of the plurality of lens toward the egress optical axis, wherein at least one of the folding optical components is shaped for manipulating the light beam and for fitting to at least one customized 3D structure of the chassis.

16. The consolidated MOPA laser module according to claim 15, wherein the chassis has a chassis portion that includes the at least one dedicated 3D structure and the at least one customized 3D structure.

17. The consolidated MOPA laser module according to claim 15, wherein at least one of the folding optical components is controllably movable by at least one component of the BTS, for adjusting a position of the respective folding optical component to the respective customized 3D structure.

18. The consolidated MOPA laser module according to claim 15, wherein at least one of the folding optical components is a pentaprism having four active surfaces, operable to internally reflect the light beam inside the pentaprism twice before emitting the light beam out of the pentaprism.

19. The consolidated MOPA laser module according to claim 15, wherein at least one of the folding optical components is a retroreflector having at least three active sides, operable to internally reflect the light beam inside the retroreflector twice before emitting the light beam out of the retroreflector.

20. The consolidated MOPA laser module according to claim 15, wherein the egress optical axis is a continuation of the entry optical axis.

21. A method of manufacturing a consolidated Master Oscillator Power Amplifier (MOPA) laser module, the method comprising:
enduringly affixing to different surfaces of a prefabricated chassis at least one component of a master oscillator laser (MO), and at least one component of a power amplifier (PA), wherein the affixing to the prefabricated chassis of the at least one MO component and the at least one PA component determines an alignment between the MO and the PA; and
after the affixing of the at least one MO component and the at least one PA component, enduringly coupling to the prefabricated chassis a beam transfer system (BTS), the BTS comprising a plurality of optical elements for transferring light outputted from the MO to the PA, for amplification.

22. The method of claim 21, wherein the affixing comprising directing the MO directly towards the PA, sensing an output of the PA resulting from the illumination, adjusting an alignment between the MO and the PA based on results of the sensing, and affixing at least one component of at least one of the MO and the PA based on the adjusted alignment.

23. The method of claim 21, further comprising measuring output of the PA at two or more different temperatures and at two or more different states of at least one controllable optical component (COC) of the BTS, computing temperature compensation information for the at least one COC, and storing the temperature correction information at a tangible memory module which is readable by a controller that is operable to modify a state of the at least one COC.

24. The method of claim 21, further comprising measuring output of the PA at two or more different temperatures and at two or more different states of at least one thermoelectric cooler (TEC) of MOPA laser module, computing temperature compensation information for the at least one TEC, and storing the temperature correction information at a tangible memory module which is readable by a controller that is operable to modify a state of the at least one TEC.

25. The method of claim 21, further comprising measuring output of the PA at two or more different temperatures and at two or more different states of at least one pump of the MO or the PA, computing temperature compensation information for the at least one pump, and storing the temperature correction information at a tangible memory module which is readable by a controller that is operable to modify a state of the at least one pump.

26. The method of claim 21, wherein the enduringly affixing is preceded by polishing at least one first surface and at least one second surface of the chassis to be parallel to one another, wherein the enduringly affixing comprising enduringly affixing the at least one component of the MO to the first surface and enduringly affixing the at least one component of the PA to the second surface.
